(19) United States
(12) Patent Application Publication
(10) Pub. No.: US 2018/0349406 A1
(43) Pub. Date: Dec. 6, 2018

(54) SHARING DATA AMONG MULTIPLE COMPUTING DEVICES

(71) Applicant: Apple Inc., Cupertino, CA (US)

(72) Inventors: Todd A. SHORTLIDGE, San Francisco, CA (US); David T. WILSON, Cupertino, CA (US); Aroon PAHWA, Palo Alto, CA (US); Pratik SOLANKI, Mountain View, CA (US)

(21) Appl. No.: 15/715,035

(22) Filed: Sep. 25, 2017

Related U.S. Application Data
(60) Provisional application No. 62/514,609, filed on Jun. 2, 2017.

(51) Int. Cl. G06F 17/30

(52) U.S. Cl. CPC G06F 17/30174; G06F 17/30371

(57) ABSTRACT

This application relates to a first computing device that stores a first set of data that is associated with an event can be configured to implement a method for resolving inconsistencies in synchronized data among multiple computing devices by carrying out the techniques described herein. In particular, the method can include the steps of (1) receiving, from a second computing device, a second set of data that is associated with the event, (2) in response to receiving a request to present data associated with the event: determining a presence of at least one inconsistency between respective corresponding data of the first and second sets of data, (3) applying rules to the at least one inconsistency to form resolved data, and (4) presenting the data associated with the event, where the data includes at least the resolved data.

### CROSS-REFERENCE TO RELATED APPLICATIONS

The present application claims the benefit of U.S. Provisional Application No. 62/514,609, entitled “SHARING DATA AMONG MULTIPLE COMPUTING DEVICES,” filed Jun. 2, 2017, the content of which is incorporated herein by reference in its entirety for all purposes.

### FIELD

The described embodiments relate generally to sharing data among computing devices. More particularly, the described embodiments involve resolving data inconsistencies in conjunction with presenting the shared data to a user.

### BACKGROUND

In recent years, there has been a proliferation in the number of computing devices owned by individuals. For example, computing devices (e.g., smartwatches, fitness trackers, smartphones, computer tablets, laptops, portable health monitors, etc.) can play an active role in monitoring a user's activities throughout the day. Notably, each of these computing devices include hardware components (e.g., sensors, memory, etc.) and software components (e.g., applications, etc.) capable of monitoring and storing data associated with the user's activities in order to provide specialized functionality that delivers a rich user experience. However, an ongoing challenge of using multiple computing devices is that each computing device often presents the user with a partial and limited representation of his or her activities throughout the day. Consider, for example, that the user lacks a holistic representation of his or her overall user activity when relying on a smartphone (e.g., to monitor sleeping patterns) and a fitness tracker (e.g., to monitor gym workouts). Moreover, it is also desirable to enable privacy safeguards to prevent unauthorized users and other computing devices from accessing the data stored at these computing devices.

Accordingly, there exists a need for an efficient and secure technique for presenting the user with a more holistic presentation of the data stored at these computing devices.

### SUMMARY

To cure the foregoing deficiencies, the representative embodiments set forth herein disclose various techniques for sharing data among computing devices. More particularly, the described embodiments involve resolving data inconsistencies in conjunction with presenting the shared data to a user.

According to some embodiments, a first computing device that stores a first set of data that is associated with an event can be configured to implement a method for resolving inconsistencies in synchronized data among multiple computing devices by carrying out the techniques described herein. In particular, the method can include the steps of (1) receiving, from a second computing device, a second set of data that is associated with the event, (2) in response to receiving a request to present data associated with the event: determining a presence of at least one inconsistency between respective corresponding data of the first and second sets of data, (3) applying rules to the at least one inconsistency to form resolved data, and (4) presenting the data associated with the event, where the data includes at least the resolved data.

According to some embodiments, a computing device can be configured to implement a method for controlling access to data items that are associated with multiple users by carrying out the techniques described herein. In particular, the method can include the steps of (1) receiving a request, from an application, to access the data items that are stored at the computing device, where the data items include at least (i) a first set of data that is associated with a first user that is stored at a first database, and (ii) a second set of data that is associated with a second user that is stored at a second database, (2) determining whether an approval for the application to access a database associated with a specific user is received, where the specific user includes at least one of the first user or the second user, (3) in response to determining that the approval for the application to access the database is received: determining that the application is restricted to accessing a specific subset of data stored at the database that is associated with the specific user, and (4) enabling the application to access the specific subset of data while preventing the application from accessing any other data stored at the database.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different computing devices that can be configured to implement different aspects of the various techniques described herein, according to some embodiments.

FIGS. 2A-2G illustrate example conceptual diagrams of sharing data among different computing devices, according to some embodiments.

FIGS. 3A-3E illustrate example conceptual diagrams of sharing data among different computing devices, according to some embodiments.

FIG. 4 illustrates a method for servicing a request to access data stored at a computing device, according to some embodiments.

FIG. 5 illustrates a method for servicing a request to modify data stored at a computing device, according to some embodiments.

FIG. 6 illustrates a method for enabling a computing device to present resolved data, according to some embodiments.

FIG. 7 illustrates a method for enabling a computing device to execute a baseline data process, according to some embodiments.

FIG. 8 illustrates a detailed view of a computing device that can be configured to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments described herein set forth techniques for sharing (e.g., synchronizing) data among computing devices that are associated with a user in order to present the user with a more holistic presentation of the user's data. In some examples, each of these computing devices can be capable of tracking the user's physical activities. However, due to technical variances in these computing devices (e.g., sensors, calibration settings, etc.), these computing devices can store non-identical data for the same event (e.g., physical activity). Consider, for example, a scenario where the user wears a smartwatch while the user is surfing, where the smartwatch tracks a total distance surfed (e.g., 1000 yards) at Mavericks during a two-hour surf session. Additionally, the user's surfboard includes a Bluetooth-enabled fitness tracker that tracks the total distance surfed (e.g., 1050 yards) by the user during the same two-hour surf session. Subsequent to the surf session, the user's computing devices can share their data (e.g., total distance surfed, etc.) in order to attempt to present the user with a consistent and complete representation of the overall activity during the surf session. However, due to aforementioned technical variances among these computing devices, upon sharing the data, these computing devices can present a non-identical representation of the user's overall activity, which can create confusion. Accordingly, these computing devices can utilize the techniques as described in greater detail herein to resolve these inconsistencies and provide the user with a more holistic representation of the user's overall activity.

According to some embodiments, techniques for resolving these inconsistencies can include a first computing device that stores a first set of data associated with an event. Subsequently, the first computing device can receive a second set of data that is associated with the event from a second computing device. In some examples, the first computing device can receive the second set of data via a storage device that is accessible to both the first and second computing devices. In other examples, the first computing device can receive the second set of data directly from the second computing device. Subsequently, in response to receiving a request to present data associated with the event, the first computing device can determine whether there are data inconsistencies between the first and second sets of data. Upon determining that there are one or more data inconsistencies, the first computing device can apply rules to resolve the one or more data inconsistencies to form resolved data. Thereafter, the first computing device can present a user with the data associated with the event, where the data includes at least the resolved data.

Moreover, the embodiments described herein set forth techniques for managing the specific data that is to be synchronized among the computing devices. In particular, these computing devices can be shared among multiple users, e.g., where a primary user can be associated with a first computing device, another primary user can be associated with a second computing device, and so forth. Consider, for example, a scenario where multiple users (e.g., a primary user and one or more secondary users, etc.) can be assigned to a single computing device. Consider further that the primary user associated with the first computing device may wish to restrict a subset of data from being shared with the second computing device. Accordingly, when sharing the data between these computing devices, the primary user associated with the first computing device can define a subset of data that is permitted to be shared with other computing devices, while preventing other subsets of data associated with the primary user from being shared with the other computing devices. In some examples, the subset of data can be defined according to specific data types, data generated by specific applications, data generated during specific time frames, and the like. Accordingly, these computing devices can utilize the techniques described herein to specify the data that is to be shared with the other computing devices.

Furthermore, the embodiments described herein set forth techniques for enabling user privacy safeguards to prevent unauthorized users and the other computing devices from accessing a user's data. In particular, each computing device can be capable of storing the shared data at its respective local storage device. Moreover, the shared data can also be stored at a storage device, which is accessible to these computing devices. However, it is noted that when specific shared data is deleted at a computing device, the specific shared data may still remain at the storage device. Notably, the specific shared data at the storage device can be vulnerable to access by the other computing devices, which is concerning when the user associated with these computing devices had intended to delete this specific data. Accordingly, these computing devices can utilize the techniques described herein to enable user privacy safeguards to prevent or minimize the risk of unauthorized users and the other computing devices from accessing this specific data.

According to some embodiments, techniques for enabling user privacy safeguards can include a first computing device managing data that is stored at a storage device. In particular, the first computing device can receive a request to modify an initial set of data that is stored at the first computing device, where the initial set of data is also stored at the storage device. In some examples, the initial set of data is being deleted by the first computing device. In response to modifying the initial set of data, the first computing device can generate a change record in accordance with this modification to the initial set of data. Subsequently, the first computing device can provide the change record to the storage device, where the change record is subsequently stored at the storage device. In some cases, the first computing device can be configured to determine whether at least one circumstance for replacing the initial set of data at the storage device is identified. If the at least one circumstance is identified, then the first computing device can provide an updated set of data to the storage device, where the storage device replaces the initial set of data with the updated set of data. In some cases, the updated set of data also replaces the changed record previously stored at the storage device. In this manner, the deletion of the initial set of data is also reflected at the storage device.

Furthermore, the embodiments described herein set forth techniques for controlling the level of access that is granted to applications and other users to data stored at the computing device. Consider, for example, that applications (established at the computing device) can be configured to access this data in order to provide specialized functionality that provides an enriched user experience. However, the computing device can store data for multiple users (e.g., two members of a family, etc.), where each user may wish to define the level of access that the application has to their respective data. Accordingly, the computing device can establish separate databases for each user, where each separate database stores data for only a specific user. In some cases, each separate database can include a dedicated application programming interface (API) that secures the data included in the database against access by applications and other users. Consider, for example, a scenario where a member can grant a surfing application access to GPS coordinates (stored in the user's database) of the user's movements in order to track a workout activity (e.g., total distance surfed) associated with the user's surf session, while denying a swimming application access to the same GPS coordinates during the same surf session in order to track a different workout activity (e.g., total distance paddled). Alternatively, the user's spouse can deny the surfing application access to GPS coordinates (stored in the spouse's database) of the spouse's movements, while granting the swimming application access to the same GPS coordinates. Accordingly, these privacy safeguards enable each specific user to control the user's respective data that is available to be shared.

Additionally, the techniques set forth herein for controlling the level of access that is granted to applications and other users to data stored at the computing device can be applied to shared user health data (e.g., patient's health records, genealogy tests, history of drug prescriptions, hospital visits, insurance information, family health background, doctor's visits, sleep records, booster shots, vaccination records, etc.). In particular, the user health data can be shared between the patient and at least one other party, which can include the patient's family members, the patient's physician, the patient's insurance provider, and so forth. In some cases, the patient's computing device can be configured to control the level of access that the at least one other party has to the patient's health data. Consider, for example, a scenario where the patient permits the patient's health insurance provider to access the patient's history of drug prescriptions and hospitals visits for reimbursement of out-of-pocket expenses paid by the patient. However, in this same scenario, the patient can also restrict sharing the patient's genealogy tests (which may suggest a genetic predisposition to certain cancers) with the patient's insurance provider. Accordingly, the patient can utilize the aforementioned privacy safeguards to control the level of access to the patient's health data that is granted to other parties.

According to some embodiments, the techniques for resolving inconsistencies in shared data between multiple computing devices can be applied to user health data. Consider, for example, a scenario where a patient stores medical records associated with taking a prescription drug (e.g., insulin). The patient's computing device can be configured to establish a medical record of a day/time of every instance when the patient takes the insulin injection. In particular, the patient's medical records can be shared with the patient's physician so as to provide a holistic presentation of the patient's health data. Additionally, the patient's medical records can include associated patient data, such as the patient's age, the patient's glucose level, the patient's weight, the patient's blood pressure, the patient's genetic data, the patient's height, the patient's blood type, and the prescribed dosage of insulin. Continuing with this example, the patient's computing device can be configured to present a notification if the patient misses a required insulin injection. However, if the patient utilizes the physician's computing device to establish a medical record that indicates that the patient took the insulin injection at the physician's office, this medical record can be subsequently shared with the computing device. In this manner, these computing devices can merge the patient's health data across different time periods in order to present a holistic presentation of the patient's health data.

Furthermore, the techniques as described herein can be applied towards managing health data (e.g., vaccination records, surgeries, etc.) for pets (e.g., dogs, cats, etc.) that are associated with these users. In some examples, a user can establish a database at the computing device that is exclusively dedicated for storing health data associated with the user's pet.

According to some embodiments, these computing devices can share media items (e.g., document files, picture files, music files, video files, webpages, etc.) with one another. Consider, for example, a scenario where a first user of a first computing device shares a document file with a second user of a second computing device. Subsequently, the second user modifies the document file to form a modified document file. In some cases, this modified document file can be subsequently shared with the first computing device. However, consider that the first and second computing device can utilize different word processing applications (e.g., different versions of the same word processing application, etc.) to present the modified document file to a user. Instead of these computing devices presenting a non-uniform version of the modified document file, both computing devices can apply rules to resolve any inconsistencies in the modified document file so as to present the first and second users with a uniform version of the modified document file.

Consider, for example, another scenario where a professional electronic music artist is producing a remix of a song at the professional musician's computing device (e.g., laptop) in collaboration with an amateur musician at the amateur musician's computing device (e.g., computer tablet). While remixing the song, different musical components (e.g., synthesizers, percussions, samplers, MIDI effects, plugins, etc.) can be applied by each of these users. However, consider that the professional musician has access to more musical components (e.g., full license of DJ software) than the amateur musician (e.g., trial license of DJ software). Accordingly, the computing devices can establish one or more rules that establish the computing device as having priority over the different computing device. In one example, both musicians are attempting to remix the same time segment of the song, but utilizing different musical components. Subsequently, when these computing devices share their respective baseline data, these computing devices can apply the one or more rules to establish that the remix of the song produced by the professional musician should be presented at both computing devices. In some examples, any inconsistencies between these versions of the same time segment of the song can be visually distinguished (e.g., highlighted, underlined, different color, etc.) such that both musicians can have an opportunity to review the full extent of the amateur musician's remix of the song, and accept/deny those changes in the presented remix of the song.

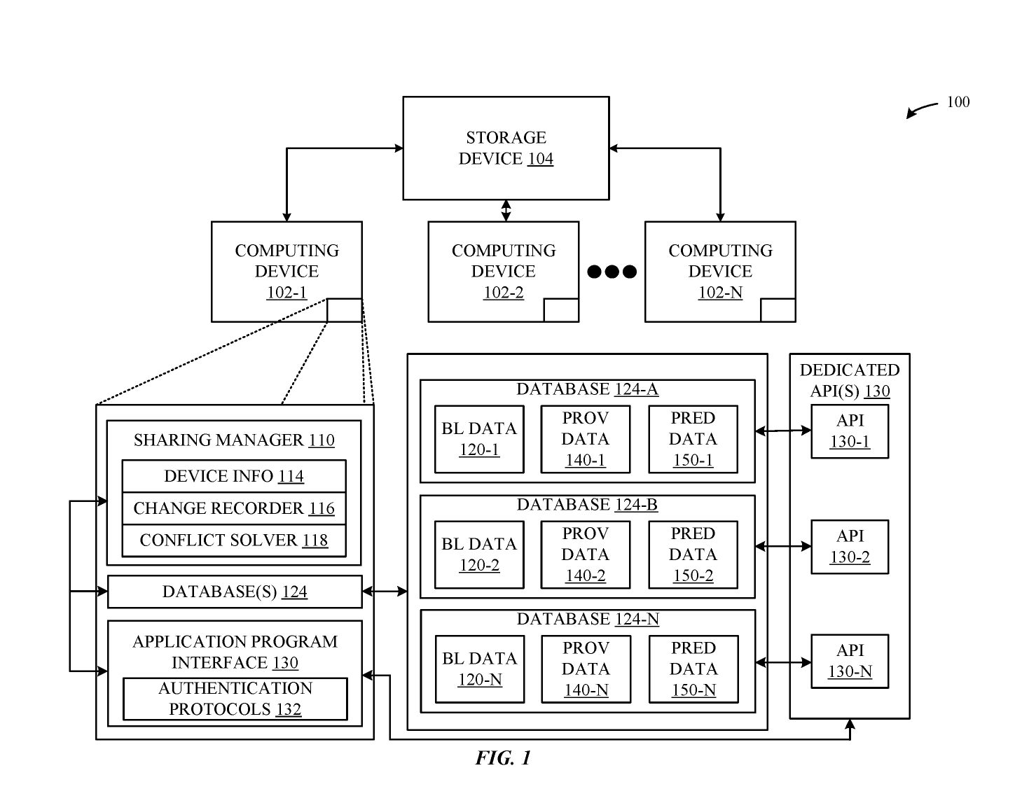

A more detailed discussion of these techniques is set forth below and described in conjunction with FIGS. 1, 2A-2G, and 3-8, which illustrate detailed diagrams of systems and methods that can be used to implement these techniques.

FIG. 1 illustrates a block diagram 100 of different computing devices that can be configured to implement various aspects of the techniques described herein, according to some embodiments. Specifically, FIG. 1 illustrates a high-level overview of a computing device 102-1 that is configured to share data (e.g., synchronize data) with other computing devices 102 (e.g., 102-2 through 102-N). In some cases, each of these computing devices 102 can utilize a storage device 104 to store the data that is shared between these computing devices 102, as described in greater detail herein. In some examples, the storage device 104 can refer to any network-accessible memory or storage device, such as a local area network storage device, cloud networking storage device, personal area network storage device, and so forth. Although not illustrated in FIG. 1, it is understood that each of the computing devices 102 can include at least one processor, at least one memory, and at least one storage device that collectively enable these computing devices 102 to operate in accordance with this disclosure. For example, in a given computing device 102, the at least one processor, in conjunction with the at least one memory, can load instructions that are stored in the at least one storage device into the at least one memory to enable the techniques described herein to be implemented. In particular, an operating system (OS) that includes a variety of applications/kernels can be executed by the at least one processor in order to implement the various techniques described herein.

For example, the OS can enable a sharing manager 110 and application program interface (API) 130 to execute on the computing device 102-1. According to some embodiments, the sharing manager 110 can be configured to service requests to share data with other computing devices (e.g., computing devices 102-2 through 102-N, etc.). Additionally, the sharing manager 110 can be configured to communicate with the API 130 in order to service requests to share data with applications that are established at the computing device 102-1/other computing devices 102. In some cases, each of the sharing manager 110 and the API 130 can be configured to access various data structures (e.g., stored in the at least one memory/at least one storage device of the computing device 102-1) that enable the sharing manager 110 and the API 130 to carry out techniques for sharing data. For example, the data structures can include device information 114, change recorder 116, conflict solver 118, database(s) 124, and authentication protocols 132, the purposes of which are described below in greater detail.

According to some embodiments, the sharing manager 110 can be configured to service any number of requests to share data that is stored at the database 124 of the computing device 102-1. In some examples, a request to share the data can be initiated by a user using the computing device 102-1. In other examples, a request to share the data can be initiated by an application that is established executed at the computing device 102-1 in order to provide specialized functionality. In other examples, the computing device 102-1 can receive a request to share data from other computing devices 102. In particular, these computing devices 102 can be pre-defined as having a master/master relationship, where a “master” computing device 102 can be capable of generating its own data, sharing its data with another “master” computing device 102, and/or modifying shared data that is generated by another “master” computing device 102. In other examples, these computing devices 102 can be pre-defined as having a parent/child relationship, where a “child” computing device 102 can be restricted to only viewing shared data that is generated by a “parent” computing device 102. In particular, the “child” computing device 102 can be prevented from modifying any shared data generated by the “parent” computing device 102. Techniques for sharing data according to these pre-defined relationships are described in greater detail herein.

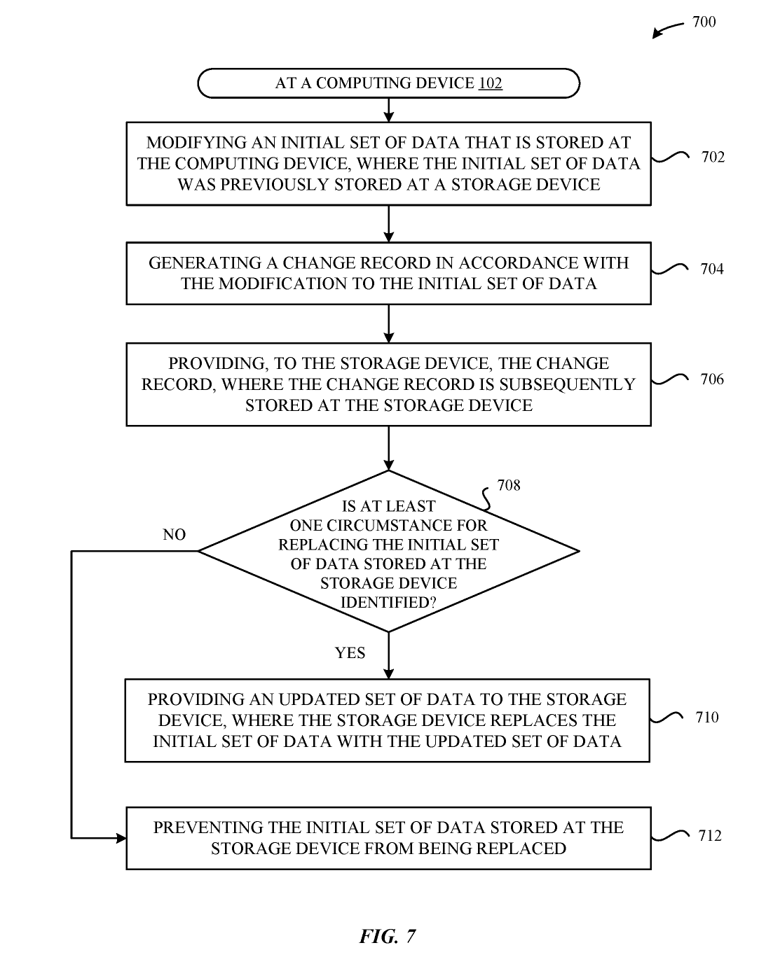

According to some embodiments, data that is to be shared between these computing devices 102 can be stored at a respective database 124 of each computing device 102. In some cases, the database 124 can include data structures that can include baseline data (e.g., BL data 120-1 through 120-N), providence data (e.g., prov data 140-A through 140-N), predicate data (e.g., pred data 150-A through 150-N), and change records (not illustrated in FIG. 1). In particular, the baseline data 120 can be shared among these computing devices 102 in conjunction with executing a baseline data process. In some cases, the baseline data process can be executed by any of these computing devices 102 in response to identifying at least one circumstance that is suitable for executing the baseline data process, as described in greater detail with reference to FIG. 7.

According to some embodiments, the baseline data process can include the computing device 102-1 providing a set of data to the storage device 104. In some examples, the set of data can include all data that is stored at the database 124 that was generated by the computing device 102-1, as well as all other data stored at the database 124 that was generated by other computing devices 102. In some examples, the data that is provided in conjunction with the baseline data process can include at least one of baseline data 120, providence data 140, predicate data 150, or change records. Subsequently, the storage device 104 can store this data at a database (not illustrated in FIG. 1) that is exclusively dedicated to storing the data that was provided by this computing device 102-1. In turn, the storage device 104 can provide this data to the different computing device 102-2, where it is subsequently stored at a respective database 124 of the different computing device 102-2. In this manner, any data that is shared between these computing devices 102 can be conveniently stored at the storage device 104, which can cache the shared data.

According to some embodiments, each of these computing devices 102 can be capable of instantiating a respective baseline data process (e.g., a subsequent baseline data process) in order to replace any data that is stored at the cloud storage device as a result of a previous baseline data process (e.g., an initial baseline data process). For example, any data that is shared between these computing devices 102, in conjunction with the initial baseline data process, can also be stored at the storage device 104. In some embodiments, any shared data included with the initial baseline data process can be associated with an initial time stamp. Subsequently, in conjunction with any of these computing devices 102 executing the subsequent baseline data process (i.e., re-baseline data process), each of these computing devices 102 can provide a set of baseline data that replaces any data stored at their exclusively dedicated database at the storage device 104.

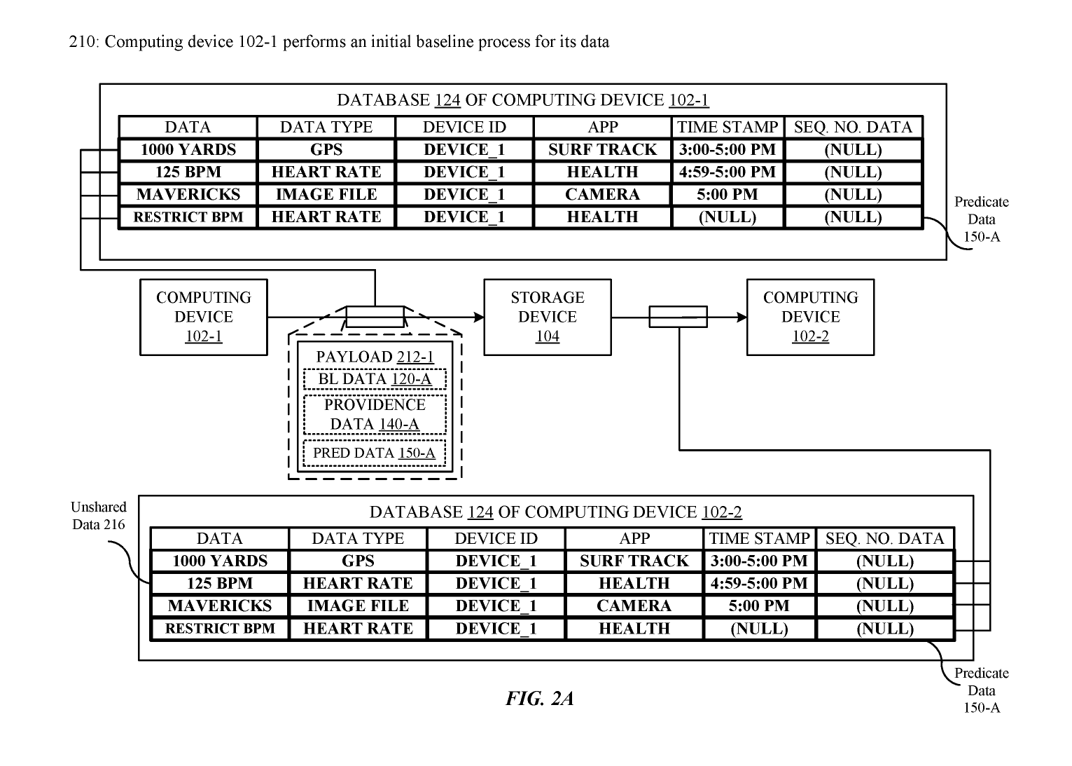

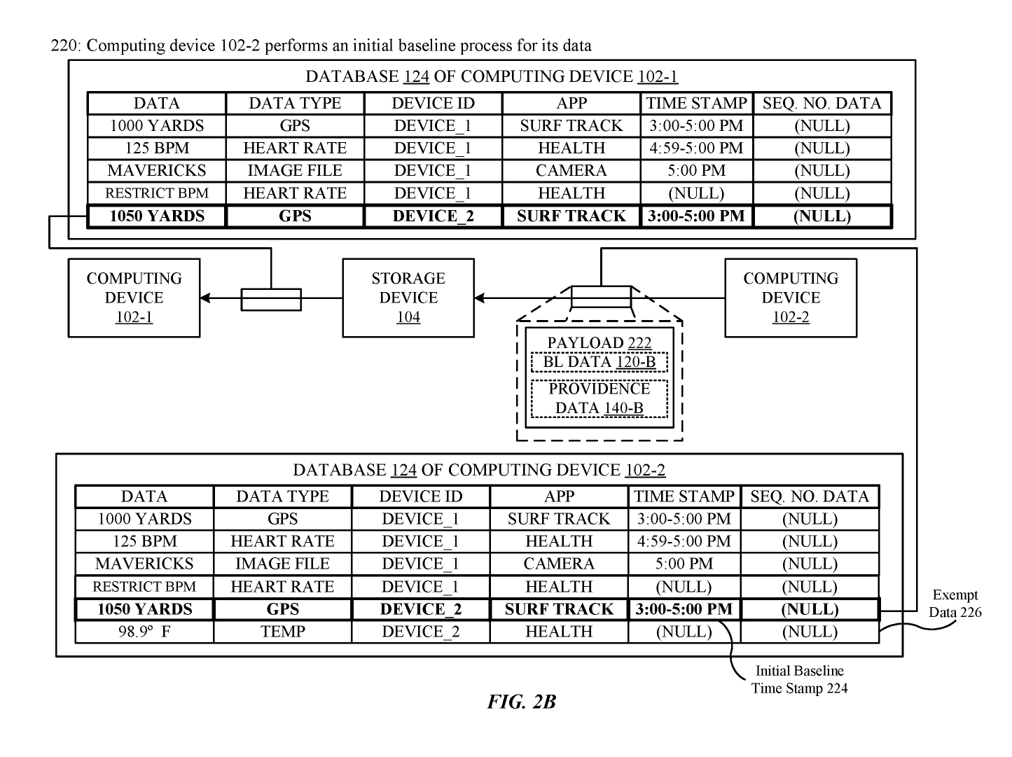

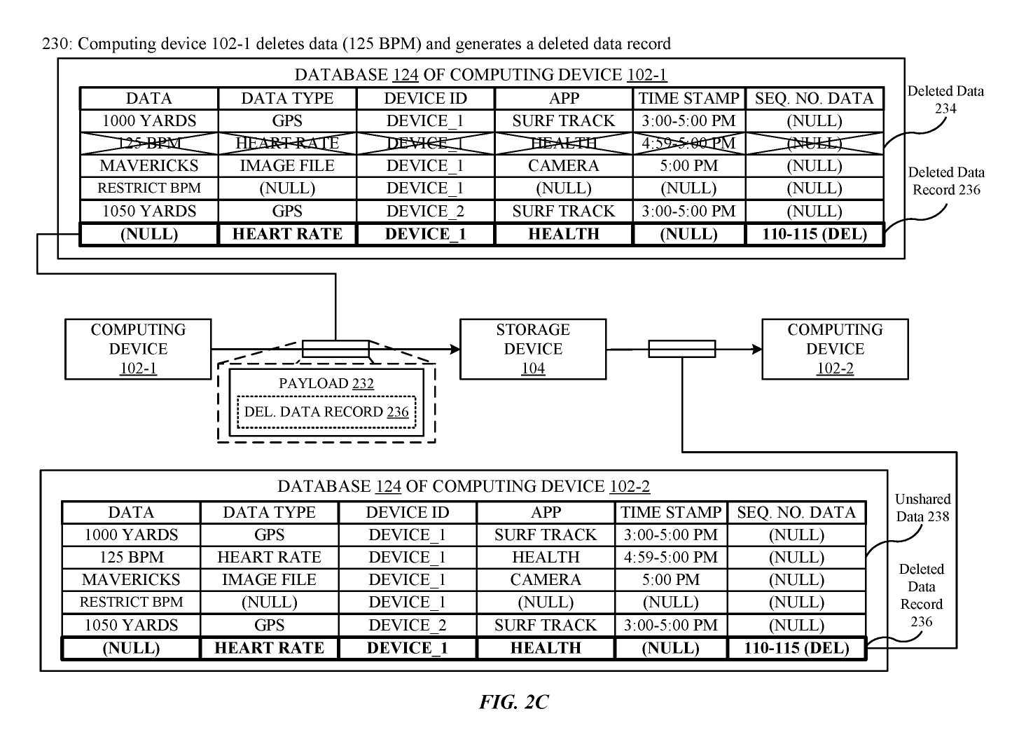

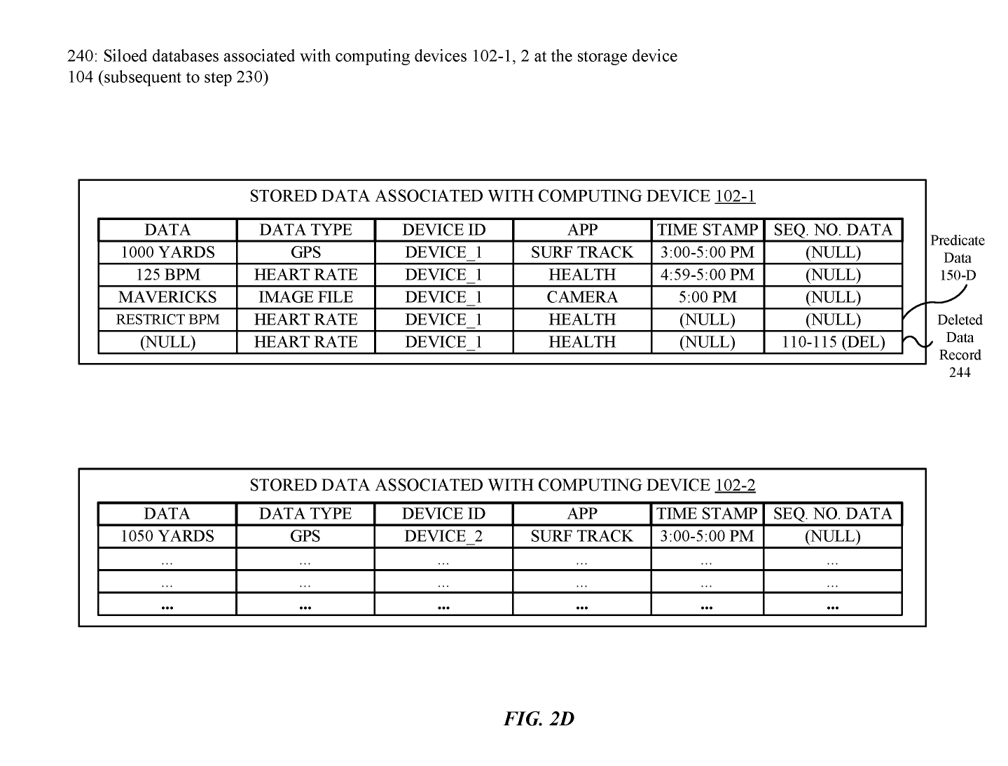

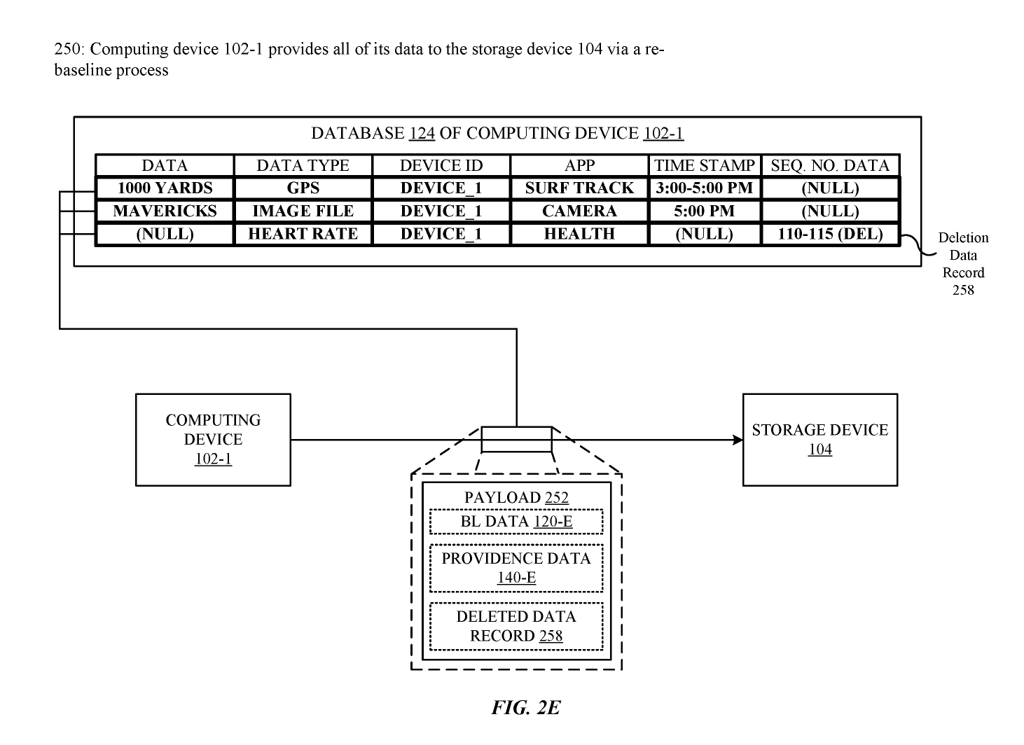

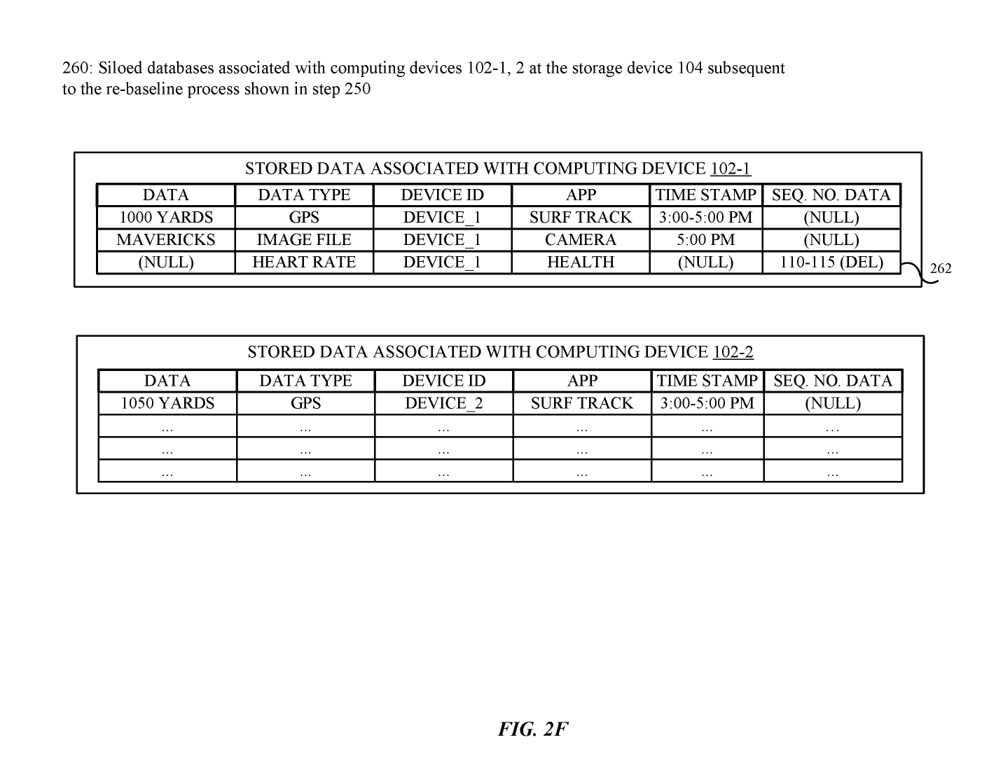

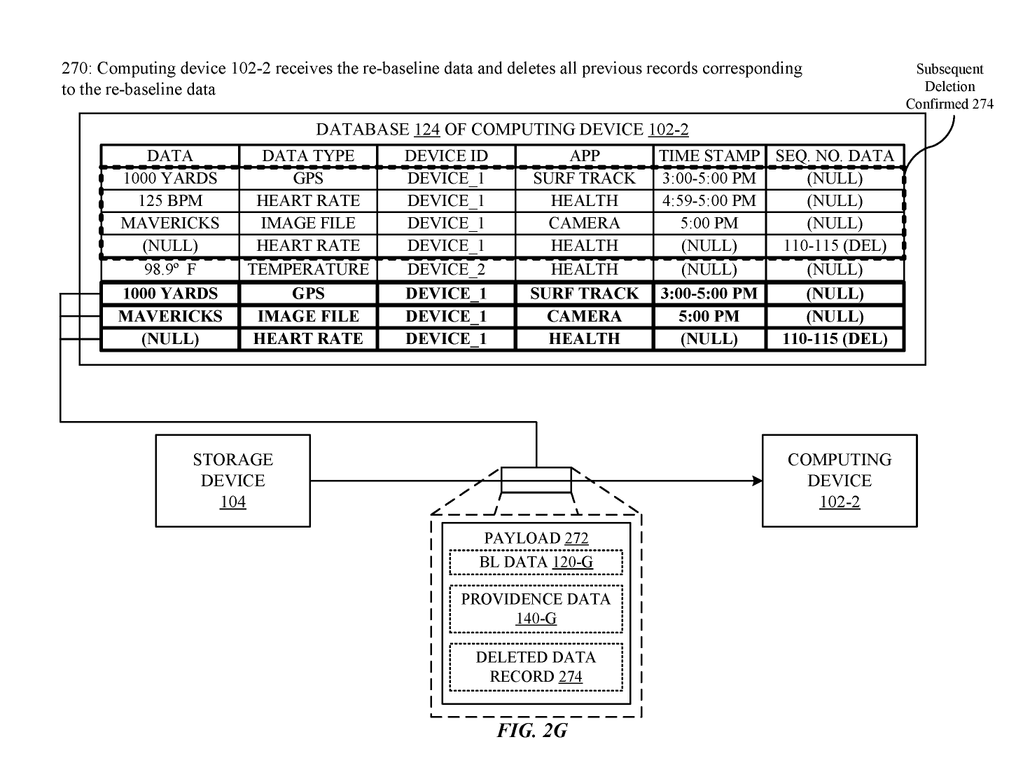

According to some embodiments, shared data, included with the subsequent baseline data process, can be associated with a subsequent time stamp. Subsequently, when the storage device 104 receives the data included with the subsequent baseline data process, the storage device 104 can compare the subsequent time stamp to the initial time stamp to determine whether to replace the data associated with the initial baseline data process. In one example, the storage device 104 can compare the time stamps of shared data (e.g., 12:00 PM vs. 9:00 PM) to determine whether to replace corresponding data stored at the cloud storage device 104. A more detailed description of this technique is described below in conjunction with FIGS. 2A-2G.

According to some embodiments, the storage device 104 can be configured to facilitate data sharing between these computing devices 102. In particular, the storage device 104 can include separate databases, such as first database that is exclusively dedicated to store only data that was provided by the computing device 102-1, and a second database that is exclusively dedicated to storing only data that was provided by the different computing device 102-2. In some cases, each dedicated database can be associated with a database identifier that corresponds to a specific device identifier associated with a particular computing device 102 that provides the data.

Additionally, with the exception of executing a baseline data process, any baseline data 120 that is stored at the dedicated database resident on the storage device 104, is generally unaffected by modifications (e.g., deletions, edits, etc.) made to corresponding baseline data 120 that is stored at the respective databases 124 of the computing devices 102. Instead, according to some embodiments, modifications to the baseline data 120, stored at a respective database 124, can be reflected in change records stored at the storage device 104. In this manner, each computing device 102 can compare its respective baseline data 120, stored at the database 124, to a corresponding baseline data 120 that is stored at the storage device 104 to confirm whether to delete the baseline data 120, as described in greater detail herein.

According to some embodiments, a computing device 102-1 can be associated with a primary user (e.g., a parent) and one or more secondary users (e.g., the parent's children). In some cases, the primary user can be differentiated from the secondary user based on their respective privileges to access data stored at a database 124 of the computing device 102-1. For example, according to some embodiments, the database 124 can include a primary database that can be exclusively dedicated to storing data associated with the primary user, and one or more secondary databases that can each be exclusively dedicated to storing data associated with the one or more secondary users.

According to some embodiments, the primary user can be capable of controlling the access to the secondary database. In some cases, the data that is to be stored at the secondary database can be provided by a different computing device 102-2. For example, the different computing device 102-2 can also store data that is associated with the secondary user. During a baseline data process that is executed by the different computing device 102-2, the data associated with the secondary user can be shared with the computing device 102-1, and subsequently stored at the secondary database 124 of the computing device 102-1.

In some cases, the primary user can manually enter data at the computing device 102-1 that is to be stored at the secondary database. For example, when the parent (i.e., primary user) takes the child (i.e., secondary user) to the physician's office to get vaccinations, the parent can establish records of these vaccinations at the secondary database.

In some cases, an application that is established at the computing device 102-1 can be configured to generate data that can be stored at the secondary database. As described in greater detail herein, each database can include a dedicated API that controls access to the secondary database. In response to granting the application access to the secondary database, the dedicated API can control access for the application to the secondary database. For example, the dedicated API can grant a heart rate monitoring application access to the secondary database associated with the parent's child. Accordingly, any heart rate measurements established by the heart rate monitoring application can be stored at the secondary database.

In some cases, the primary user can connect a secondary device (e.g., health monitor, weight scale, etc.) to the computing device 102-1 via a Bluetooth connection. In response to connecting the secondary device, the computing device 102-1 can present a notification to the primary user to inquire whether any data generated by the secondary device can be stored at the secondary database. For example, when the child's heart rate is measured using the health monitor, the heart rate can be stored at the secondary database. Additionally, it is noted that any of the techniques as described herein can be applied to storing data that is associated with the primary user at the primary database.

According to some embodiments, the sharing manager 110 can be configured to access the device information 114 in conjunction with servicing requests to share data with other users/other computing devices 102. In particular, the sharing manager 110 can utilize the device information 114 to generate providence data 140. Furthermore, the providence data 140 can be associated with the baseline data 120 that is provided during a baseline data process. In some cases, the providence data 140 can refer to identifying characteristics that describe the baseline data 120. The sharing manager 110 can access the device information 114 in order to establish the identifying characteristics of the providence data 140.

According to some embodiments, the device information 114 can be based on hardware/software properties associated with the computing device 102. In some examples, the providence data 140 can provide identifying characteristics, such as a specific device identifier of the computing device 102 that generated this baseline data 120, a version number of the application that generated this baseline data 120, a version number of the application having access to this baseline data 120, a user account associated with this baseline data 120, a time stamp of when this baseline data 120 was provided to the storage device 104, a time of when this baseline data 120 was generated at the computing device 102, the computing devices 102 that have been granted access to this baseline data 120, a specific data type associated with this baseline data 120, the type of computing device (e.g., smartwatch, smartphone, etc.) that generated this baseline data 120, and so forth. In some cases, the device information 114 (of which the providence 140 is based on) can include a device identifier (ID) associated with the computing device 102, where the device ID is based on a phone number, a subscriber identity module (SIM) card, and so on. In other examples, the device information 114 can include user account information of the one or more users associated with the computing device 102, where the user account information is based on an e-mail account, a social network account, a social media account, and so on. In this manner, when data is shared between computing devices 102 (e.g. during baseline data process, modifications to baseline data, etc.), the sharing manager 110 can access this providence data 140 to provide identifying characteristics that describe the baseline data 120.

According to some embodiments, the change recorder 116 can establish providence data 140 that indicates a time stamp (e.g., time of day, etc.) of when the baseline data 120 was recorded by the computing device 102-1. In particular, the time stamp can include a beginning time stamp that indicates when the change recorder 116 began recording the baseline data 120, and an end time stamp that indicates when the change recorder 116 stopped recording the baseline data 120. In one example, when the computing device 102-1 continuously monitors the user's average heart rate (e.g., 75 BPM) throughout the day, the change recorder 116 can establish a specific time stamp (e.g., “Tuesday, 12:00 AM-Wednesday, 12:00 AM”) for that specific time period. Additionally, when the computing device 102-1 monitors the user's heart rate (e.g., 120 BPM) during a period of strenuous exercise during that same day, the change recorder 116 can establish a specific time stamp (e.g., “Tuesday, 7:00-7:10 am”) for that specific time period. In some cases, these specific time stamps can be utilized by the conflict solver 118 to present a more holistic presentation of the user's activity throughout the day, as described in greater detail herein. In one example, the computing device 102-1 can assign weighted values to the respective heart rates associated with the time stamps (“Tuesday, 12:00 AM-Wednesday, 12:00 AM”) and “Tuesday, 7:00-7:10 am”) to present a weighted user heart rate (e.g., 80 BPM). In another example, the computing device 102-1 can average the respective heart rates associated with these time stamps to present an average user heart rate (e.g., 97.5 BPM). In another example, the computing device 102-1 can substitute the user's heart rate (e.g., 120 BPM) for the specific time stamp (“Tuesday, 7:00-7:10 am”) for the user's heart rate during the corresponding time period that was captured by the specific time stamp (“Tuesday, 12:00 AM-Wednesday, 12:00 AM”).

According to some embodiments, the sharing manager 110 can utilize the change recorder 116 to identify when changes are made to shared baseline data 120. In particular, the change record 116 can be configured to establish providence data 140 (e.g., respective time stamps for the baseline data 120), that identify different versions of baseline data 120, and establish change records in response to modifying the baseline data 120. In some cases, the change recorder 116 can establish change records in conjunction with determining that the baseline data 120 has been modified. In some cases, each change record can include one or more specific sequence numbers and a modification identifier. For example, the modification identifier can specify whether the baseline data 120 stored at the database 124 of the computing device 102-1 has been deleted (“DEL”), added (“ADD”), or edited (“EDT”). Additionally, in some examples, the change record can be associated with a unique identifier. For example, when the baseline data 120 is deleted, the corresponding change record (e.g., deleted data record) for that baseline data 120 does not include any personal information (e.g., the baseline data). In this manner, another computing device cannot utilize the deleted data record to determine any of the identifying characteristics of the deleted baseline data. However, the unique identifier of the deleted data record can be utilized by the sharing manager 110 to link the deleted data record to the deleted baseline data.

According to some embodiments, the sharing manager 110 can share the change record with the different computing device 102-2 (that stores the corresponding baseline data 120). In response to receiving the change record, the different computing device 102-2 can be configured to alter the manner in which the baseline data 120 is presented to a user of the different computing device 102-2/shared with an application established at the different computing device 102-2. Consider for example, a scenario where the baseline data 120 corresponds to a photo, which was previously shared between these computing devices 102-1,2, and was subsequently deleted at the computing device 102-1. Subsequently, the computing device 102-1 can provide the different computing device 102-2 with a change record indicative of this modification. In response to receiving this change record, the different computing device 102-2 can prevent this photo from being presented to a user of the different computing device 102-2/shared with a photo application established at the different computing device 102-2. However, as described in greater detail herein, the different computing device 102-2 cannot confirm that the user of the computing device 102-1 intended to permanently delete this photo. As a result, the photo remains stored at the database 124 of the different computing device 102-2. In some cases, the different computing device 102-2 can rely upon a subsequent baseline data process executed by the computing device 102-1 to confirm that the user truly intended to delete this photo, as described in greater detail herein.

Additionally, the sharing manager 110 can be configured to implement additional data privacy techniques by establishing predicate data 150. Consider, for example, a scenario where one or more users associated with a computing device 102-1 desire to control the level of access that other computing devices 102 and applications have to their respective data (e.g., baseline data 120, providence data 140, predicate data 150, change records, etc.) stored at the database 124. To implement data privacy safeguards, the predicate data 150 can define a specific subset of each user's respective data that is enabled to be shared with applications/other users, and define other subsets of the user's respective data that is restricted from being shared. For example, the predicate data 150 can deny/grant access to specific data types, deny/grant access to data generated by specific applications, deny/grant access to data generated during a specific time period, deny/grant access to data that satisfies a standard deviation threshold, deny/grant access to specific users, deny/grant access in accordance with a parent/child relationship, and the like. Notably and beneficially—the use of predicate data 150 represents another technique for enabling data privacy.

According to some embodiments, the sharing manager 110 can be configured to present shared data to one or more users of these computing devices 102-1,2. In particular, this shared data can be generated by each of these computing devices 102-1,2 in conjunction with an occurrence of an event (e.g., user's surf session, a collaborative document editing process between multiple users, or remixing a single song by multiple musicians, etc.). In response to receiving a request to present data associated with the occurrence of the event, each of these computing devices 102-1,2 can be configured to present the shared data. However, consider, for example, a scenario where the data generated by these two computing devices 102-1,2 is non-identical and inconsistent due to technical variances between these two computing devices 102-1,2. In some examples, the technical variations can include differences in hardware components, software components, calibration settings, user preferences, system preferences, machine-learning algorithms, and the like. Accordingly, in order to present the one or more users with a consistent presentation of this shared data, the sharing manager 110 can be configured to utilize the conflict solver 118 to resolve at least one inconsistency between respective corresponding data that is generated by these two computing devices 102,1-2.

In particular, in response to receiving a request to present data associated with the event, the computing device 102-1 can compare respective corresponding data associated with first and second data sets generated by these two computing devices 102-1,2 to determine if there is at least one inconsistency. In response to determining that there is at least one inconsistency, the sharing manager 110 can utilize the conflict solver 118 to resolve the at least one inconsistency by forming resolved data. In particular, the conflict solver 118 can apply one or more rules to resolve this at least one inconsistency such as to present uniform data between these computing devices 102-1,2. Notably and beneficially—the sharing manager 110 can also utilize the conflict solver 118 to prevent duplication of identical data from being presented at these computing devices 102.

According to some embodiments, the conflict solver 118 can be configured to identify corresponding sets of baseline data 120 that are associated with an event. As previously described herein, the providence data 140 provide identifying characteristics that describe these baseline data 120. Accordingly, the conflict solver 118 can access the providence data 140 to confirm that sets of baseline data 120 indeed correspond to one another. For example, instead of confusing a first set of baseline data (“140”) as corresponding to a second set of baseline data (“140”), the conflict solver 118 can determine that these first and second sets of data actually refer to different data types, such as beats per minute (a person's heart rate) and beats per minute (electronic dance music), respectively. Thus, the conflict solver 118 will not attempt to identify at least one inconsistency between these two sets of data. In particular, the conflict solver 118 can utilize the respective providence data 140 for each respective set of data (e.g., device identifier, version number of application, time stamp, time generated, user account that generated data, etc.) to establish a level of similarity. By comparing respective providence data 140, the conflict solver 118 can be configured to calculate the level of similarity between corresponding sets of baseline data 120. Additionally, the conflict solver 118 can calculate a confidence level that is associated with the level of similarity. For example, a higher confidence level can be calculated when there are a large number of providence data 140 of the respective baseline data 120 that are identical to one another. Consider, for example, a scenario where the conflict solver 118 receives a request to compare a first set of baseline data (“1000.01”) and a second set of baseline data (“1000.011”). Although these sets of baseline data 120 are nearly identical, without their respective providence data 140, the conflict solver 118 is left to calculate a low confidence level. Continuing with this example, the first set of baseline data (“1000.01”) is associated with the following providence data (“DATA TYPE: TOTAL DISTANCE SURFED,” “APP: SURF TRACK,”), and the second set of baseline data (“1000.011”) is associated with the following providence data (“DATA TYPE: TOTAL DISTANCE SURFED,” “APP: SURF TRACK”). Accordingly, due to their identical providence data 140, the conflict solver 118 can calculate with high confidence that these different sets of data correspond to one another. In turn, the conflict solver 118 can determine whether these different sets of data include at least one inconsistency, as described in greater detail herein.

Additionally, in some embodiments, the first and second sets of baseline data 120 that are generated by these computing devices 102-1,2 can include consistent respective corresponding data in addition to inconsistent respective corresponding data. For example, the first set can include baseline data (“1000 YARDS,” “125 BPM,” and “2000 CALORIES”), and the second set can include baseline data (“1050 YARDS,” “125 BPM,” and “2000 CALORIES”). Accordingly, in conjunction with establishing the resolved set of data, the conflict solver 118 can apply the one or more rules to the inconsistent data (e.g., “1000 YARDS” and “1050 YARDS”), while preventing the consistent data (“125 BPM” and “2000 CALORIES”) from being resolved. Thus, in generating the at least one resolved set of data that includes (“125 BPM,” “2000 CALORIES,” and “1050 YARDS”), the at least one resolved set of data can refer to the consistent data that was included in the first and second sets. In other cases, where there is no inconsistency among the first and second sets of baseline data 120, then both computing devices 102-1,2 can be configured to present the first and second sets of data. In this case, these computing devices 102-1,2 do not present duplicates of the same data. Rather, referring to another example, where the first set includes the baseline data (“1000 YARDS,” “125 BPM”), and the second set includes the baseline data (“2000 CALORIES”), then each of these computing devices 102-1,2 can present the first and second sets of baseline data that includes (“1000 YARDS,” “125 BPM,” and “2000 CALORIES”).

According to some embodiments, the one or more rules that are utilized by the conflict solver 118 to resolve the at least one inconsistency can be stored at the respective database 124 of these computing devices 102. In some cases, these one or more rules can be shared between these computing devices 102 as providence data 140 that is attached to the baseline data 120. In either case, each computing device 102 can access the same set of rules to resolve the at least one inconsistency to apply a consistent approach in presenting the baseline data 120 associated with the event. Additionally, it is noted that the storage device 104 can be uninvolved in resolving the at least one inconsistency.

According to some embodiments, the one or more rules can be based on system settings, hardware components, software components, calibration settings, user preferences, system preferences, machine-learning algorithms, and the like. In some cases, the one or more rules can be organized as a list, where each of the one or more rules are assigned a rank within the list. By compiling these rules in a list, the conflict solver 118 can dynamically reorder these rules based on changing conditions (e.g., when the baseline data 120 is received, new rules are added to the list, etc.). In one example, a list of rules can include: (1) a user preference that prioritizes heart rate data generated by a fitness tracker over corresponding heart rate data generated by a smartphone; (2) a system setting that establishes that a global positioning satellite (GPS) system of a computer tablet is more accurate in generating GPS coordinates and, therefore is prioritized over the fitness tracker that generates corresponding GPS coordinates; and (3) a machine-learning algorithm that establishes priority of the fitness tracker over the smartphone in generating corresponding caloric data as the fitness tracker is more frequently used by the user to track caloric data. In one example, where the computing devices 102 are identical in hardware components (e.g., heart rate sensor) and applications (e.g., “SURF TRACK”), a rule can prioritize the computing device 102 that established the “SURF TRACK” more recently. In another example, the computing devices 102 can prioritize baseline data 120 that has been modified by an application over corresponding un-altered baseline data 120. In this example, the computing device 102 tracks a heart rate of (“120 BPM”). However, a fitness tracker application can include more sophisticated software that can provide a more accurate assessment of the heart rate, and thus modifies the original data of (“120 BPM” to “125 BPM”). Accordingly, the rule can establish that this modified data is to be prioritized or preferred over the original data.

According to some embodiments, the resolved data generated by the conflict solver 118 can be dependent upon the time and conditions associated with when the request to present data associated with the event was received. In some examples, the conflict solver 118 determines whether there is at least one inconsistency when the different sets of baseline data are received. In any case, if these computing devices 102 do not include the same sets of data, then even if applying the same rules, each computing device 102 can arrive at a different presentation of the data.

According to some embodiments, the computing device 102-1 can service requests by an application (e.g., surf tracker, camera, photo processing application, etc.) to access data (e.g., baseline data 120, providence data 140, predicate data 150, change records, etc.) stored at the database 124. In particular, the database 124 can include separate databases (e.g., 124-A through 124-N) for each respective user that is associated with the computing device 102-1. For example, data for a user of the computing device 102-1 can be exclusively stored at database 124-A, and data for the user's spouse can be exclusively stored at database 124-B. Additionally, each separate database 124 can include a dedicated API (e.g., 130-1 through 130-N). Continuing with this example, access to the database 124-A can be controlled by API 130-1, and access to the database 124-B can be controlled by API 130-2. In this manner, the dedicated API 130 for each database 124 can enable a user to share the user's data independently of any other users.

According to some embodiments, in response to receiving a request from the application to access a database 124 of the computing device 102-1, the computing device 102-1 can be configured to present one or more users associated with the computing device 102-1 with a notification that is in accordance with this request. Prior to accessing the database 124, the application lacks knowledge regarding the one or more users associated with the computing device 102-1, such as each user's respective data, and so forth. Subsequent to presenting the notification, a specific user of the computing device 102-1 can grant the application access to the specific user's database 124. In some cases, when servicing the request by the application, the specific user can utilize predicate data 150, as previously described herein, to control the level of data that is accessible to the application (e.g., restrict data types, restrict specific time periods, etc.) In some cases, the API 130 can control access by the applications (established at the computing device 102-1, established at other computing devices 102) to the data stored at the specific user's database 124. For example, the API 130 can establish authentication protocols 132 (e.g., token-based) for each application. According to some embodiments, the dedicated API 130 can utilize the authentication protocols 132 to implement privacy safeguards for each separate database 124 of the computing device 102-1. In particular, when the specific user approves of the request to access data stored at the specific user's database 124, the dedicated API 130 for that specific user's database 124 can provide the application with a specific token (e.g., token 0) for the database 124. For example, the API 130 can establish a correlation between the specific token provided to the application and the 124. Beneficially, in this manner, the API 130 can also be configured to grant different applications access to the same database 124 by providing each of these applications with different tokens. Subsequently, when the application provides a subsequent request to gain access to the database 124, the API 130 can verify whether the specific token is valid before granting the application continued access to the database 124. In some cases, the specific user can deny the application continued access to the database 124 by revoking the application's specific token for the database 124.

According to some embodiments, subsequent to the application having obtained access to the database 124 associated with the specific user, the application can provide another request to the computing device 102-1 to gain access to another database 124 that is associated with another specific user. Consider, for example, a scenario where the application can be configured to control a weight scale that is communicatively coupled to the computing device 102-1 via a Bluetooth connection. In particular, multiple users of the computing device 102-1 may desire to utilize the application to record their respective weights using the weight scale. In order to separately access each user's database 124, the application can be required to provide the dedicated API 130 associated with each user's database 124 with a specific token. In this manner, the computing device 102-1 can enable individual sharing of data stored at each user's database.

According to some embodiments, the sharing manager 110 and the API 130 can be configured to communicate with one another in order to provide enhanced sharing functionality. Consider, for example, a scenario where multiple users (e.g., two members of a family) store their respective data in separate databases 124 of a computing device 102-1. In this example, a user can grant a surfing application access to GPS coordinates (stored in the user's database 124-A) related to the user's movements in order to track a workout activity (e.g., total distance surfed) associated with the user's surf session, while denying the surfing application access to a number of calories expended (also stored in the user's database 124-A) during the same surf session. Additionally, the user can deny the swimming application access to the same GPS coordinates recorded during the same surf session, while granting the swimming application access to the number of calories expended during the surf session. Alternatively, the user's spouse can deny the surfing application access to GPS coordinates (stored in the spouse's database 124-B), while granting the swimming application access to the same GPS coordinates. In this manner, each user can control at an individual data level, the data that is available to applications and other computing devices 102.

Although not illustrated in FIG. 1, the computing device 102 can include various hardware components, e.g., sensor components. In particular, these sensor components can be configured to generate the data (e.g., baseline data 120, providence data 140, predicate data 150, change records, etc.) that is stored at the database 124 and that is shared between these computing devices 102. In some examples, these sensor components can include at least one of an altitude pressure sensor, a temperature sensor, an ambient light-detection sensor, a proximity sensor, a global positioning system (GPS) sensor, an accelerometer, a gyroscope, a barometer, a fingerprint sensor, a retinal sensor, a facial detection sensor, a force pressure sensor of a display module of the computing device 102, a capacitive sensor of a display module of the computing device 102, a Hall effect sensor, and so forth. In some cases, data can be generated by any one of these hardware components and subsequently stored at the database 124. In other cases, data generated by any one of these hardware components can be modified by an application that is established at the computing device 102.

Although not illustrated in FIG. 1, the computing devices 102 can include various hardware components, e.g., one or more wireless communications components. In particular, the wireless communications components can include at least one of a wireless local area network (Wi-Fi) component, a global positioning system (GPS) component, a cellular component, an NFC component, an Ethernet component, or a Bluetooth component. According to some embodiments, data can be transmitted between the computing devices 102 and the storage device 104 using any wireless communications protocol implemented by the wireless communications components. It will be understood that the various computing devices 102 can include hardware/software elements that enable the computing devices 102 to implement the techniques described herein at varying levels.

According to some embodiments, data that is transmitted between these computing devices (e.g., computing device 102-1 through 102-N, storage device 104, etc.) can be included in a secured payload. In some examples, the payload can be secured via encryption keys, hashing algorithms, and other types of security protocols. In some cases, these computing devices 102-1,2 can share encryption keys (e.g., using public key cryptography, symmetric keys, etc.) with one another so as to establish a secure communications channel for sharing data. In some cases, the computing device 102-1 can include a pair of cryptographic keys (e.g., a public key and corresponding private key). In particular, the private key can be utilized by the computing device 102-1 to decrypt any encrypted payload that is generated by the different computing device 102-2 using the public key. In some cases, in conjunction with the different computing device 102-2 executing a baseline data process, the payload generated by the different computing device 102-2 can be encrypted using the public key. Subsequently, the encrypted payload can be provided to the storage device 104, where, in turn, the storage device 104 provides the encrypted payload to the computing device 102-1. The computing device 102-1 can utilize the private key to decrypt the encrypted payload. In this manner, any computing devices that lack the private key are unable to access the data included in the encrypted payload. For example, the storage device 104 is unable to access the encrypted payload without the private key.

FIGS. 2A-2G illustrate conceptual diagrams of computing devices 102-1,2 servicing requests to share data, according to some embodiments. Specifically, FIG. 2A illustrates a conceptual diagram 210 of an example scenario in which a computing device 102-1 services a request to execute an initial baseline data process through the utilization of data that is stored at a database 124 of the computing device 102-1, as previously described herein. In this scenario, the computing device 102-1 is communicatively coupled to a storage device 104. Additionally, the storage device 104 is communicatively coupled to a different computing device 102-2.

According to some embodiments, the step 210 illustrated in the conceptual diagram of FIG. 2A can be preceded by the computing device 102-1 storing data—e.g., baseline data 120, providence data 140, predicate data 150, change records, etc.—at its database 124. In some examples, the data can be generated in conjunction with executing applications that are established at the computing device 102-1. In this example, in conjunction with executing the applications (“SURF TRACK,” “HEALTH,” and “CAMERA), the data (“1000 YARDS,” “125 BPM,” and “MAVERICKS”) were respectively generated during an event (e.g., the user's afternoon surf session). Subsequently, this data can be stored at the database 124. As previously described herein, the API 130 can control the access to this database 124 that is afforded to these applications.

As illustrated in FIG. 2A, a first step 210 can involve the computing device 102-1 receiving a request to execute an initial baseline data process. In conjunction with executing the initial baseline data process, the computing device 102-1 can identify initial baseline data 120-A that is to be shared with the different computing device 102-2. Additionally, the initial baseline data 120-A can be associated with providence data 140-A. As previously described herein, the providence data 140-A can refer to identifying characteristics that describe the initial baseline data 120. For example, the initial baseline data (“1000 YARDS”) can include the following providence data: (“DATA TYPE: GPS,” “DEVICE ID: DEVICE_1,” “APP: SURF TRACK,” and “TIME STAMP: 3:00-5:00 PM”). In this example, the time stamp (“TIME STAMP: 3:00-5:00 PM”) can represent the time period for when the computing device 102-1 monitored the total distance surfed by the user. Additionally, and as previously described herein, in conjunction with executing the initial baseline data process, the computing device 102-1 can establish an initial baseline time stamp (not illustrated) for each initial baseline data 120-A that is descriptive of when the initial baseline data process was executed. The aforementioned types of providence data described herein are merely examples, and do not represent an exhaustive list of the different types of providence data that describe the baseline data (e.g., initial baseline data, subsequent baseline data, etc.).

According to some embodiments, the computing device 102-1 can generate predicate data 150-A that is associated with the initial baseline data 120-A. In this example, the predicate data (“RESTRICT BPM”) is associated with the initial baseline data (“125 BPM”). As previously described herein, the predicate data 150-A can define a specific subset of data that the user of the computing device 102-1 wishes to restrict from being shared with a user of the different computing device 102-2 and an application established at the different computing device 102-2. In this example, the predicate data 150-A can restrict the initial baseline data (“125 BPM”) from being shared with the user of the different computing device 102-2 without necessitating that this initial baseline data 120-A be deleted from the database 124 in conjunction with the initial baseline data process.

As illustrated in FIG. 2A, the first step 210 can involve the computing device 102-1 providing a payload 212 to the storage device 104. According to some embodiments, the payload 212 can include the initial baseline data 120-A, the providence data 140-A, and predicate data 150-A. In response to receiving the payload 212, the storage device 104 can store the baseline data 120-A, the providence data 140-A, and the predicate data 150-A at a database that is exclusively dedicated to storing data provided by the computing device 102-1. In turn, the storage device 104 can provide a different payload 212 to the different computing device 102-2, where the different payload 212 includes the baseline data 120-A, the providence data 140-A, and the predicate data 150-A. Subsequently, the baseline data 120-A, the providence data 140-A, and the predicate data 150-A can be stored at a database 124 of the different computing device 102-2, as illustrated in FIG. 2A. In this example, the initial baseline data (“125 BPM”) that is stored at the database 124 of the different computing device 102-2 can be referred to as unshared data 216, as specified by the predicate data (“RESTRICT BPM”).

As illustrated in FIG. 2B, a second step 220 can involve the different computing device 102-2 receiving a request to execute an initial baseline data process of its initial baseline data 120-B. According to some embodiments, the step 220 can be preceded by the different computing device 102-2 storing data at its database 124 in conjunction with executing an application (“SURF TRACK”) in order to generate the initial baseline data (“1050 YARDS”). In this example, the initial baseline data (“1000 YARDS” generated by computing device 102-1) and (“1050 YARDS” generated by different computing device 102-2) can refer to baseline data 120 generated during the same surf session. For example, the computing device 102-1 can refer to a smartwatch worn on the user's wrist and the computing device 102-2 can refer to a smartphone that was paired to a fitness tracker that was included in the user's surfboard during the same surf session. As illustrated in FIG. 2B, providence data 140-B is associated with each initial baseline data 120-B. In this example, the initial baseline data (“1050 YARDS”) can include the following providence data: (“DATA TYPE: GPS,” “DEVICE ID: DEVICE_2,” “APP: SURF TRACK,” and “TIME STAMP: 3:00-5:00 PM”). In particular, the initial baseline time stamp 224 (“TIME STAMP: 3:00-5:00 PM”) can represent the time period of when the different computing device 102-2 monitored the total distance surfed by the user.

According to some embodiments, the different computing device 102-2 can also define exempt data 226 (“98.9° F.”) that is prevented from being shared with the computing device 102-1. In this example, the exempt data 226 (“98.9° F.”) can be generated in conjunction with executing an application (“HEALTH”). In some examples, the exempt data 226 can be defined by predicate data 150 that is established by the different computing device 102-1. Thus, this exempt data 226 is not provided to the computing device 102-1.

As illustrated in FIG. 2B, the second step 220 can involve the different computing device 102-2 providing a payload 222 that can include the initial baseline data 120-B and the providence data 140-B to the storage device 104. In turn, the storage device 104 can store the initial baseline data 120-B and the providence data 140-B at a database that is exclusively dedicated to storing data provided by the different computing device 102-2. In turn, the storage device 104 can provide a different payload 222 to the computing device 102-1 that includes the initial baseline data 120-B and the providence data 140-B.

As illustrated in FIG. 2C, a third step 230 can involve the computing device 102-1 deleting the initial baseline data (“125 BPM”), as indicated by the deleted data 234. In response to deleting the initial baseline data (“125 BPM”), the computing device 102-1 can establish a deleted data record 236 that specifies that the initial baseline data (“125 BPM”) was deleted. In this example, the deleted data record 236 can be identified by specific sequence numbers (“110-115”) and a modification identifier (“DEL”). Referring back to FIG. 2A, the user of the computing device 102-1 elected to restrict the initial baseline data (“125 BPM”) instead of deleting this initial baseline data. Returning back to FIG. 2C, in this example, the user of the computing device 102-1 has deleted the initial baseline data (“125 BPM”) to also prevent this initial baseline data from being shared with the different computing device 102-2. Accordingly, when the different computing device 102-2 receives the deleted data record 236 from the computing device 102-1, the different computing device 102-2 can prevent this initial baseline data (“125 BPM”) from being shared. For instance, the different computing device 102-2 can delete this initial baseline data from its database 124 upon receiving the deleted data record 236.

According to some embodiments, the third step 230 can involve the computing device 102-1 providing a payload 232 that includes the deleted data record 236 to the storage device 104. In turn, the storage device 104 can store the deleted data record 236 in the respective database for the computing device 102-1, and subsequently, provide the deleted data record 236 to the different computing device 102-2 in a different payload 232. As previously described herein, the different computing device 102-2 can update its initial baseline data (“125 BPM”) by utilizing the deleted data record 236. In this example, the initial baseline data (“125 BPM”) can be referred to as unshared data 238, which the different computing device 102-2 prevents from being presented to the user and from being shared with any applications established at the different computing device 102-2. However, in some cases, the initial baseline data (“125 BPM”) remains stored at the database 124 of the different computing device 102-2. For example, the different computing device 102-2 can be prevented from deleting the initial baseline data (“125 BPM”) until the different computing device 102-2 receives a notification (e.g., via a subsequent baseline data process) that confirms that the user of the computing device 102-2 intended to permanently delete this initial baseline data 120-A, as described in greater detail herein.

According to some embodiments, FIG. 2D illustrates a fourth step 240 that represents the separate databases of the storage device 104 subsequent to the third step 230 (as described in FIG. 2C). As previously described herein, the storage device 104 can include separate databases, where separate databases are exclusively dedicated to storing the data provided by the computing device 102-1 and the different computing device 102-2. In this manner, the data provided by each of these computing devices 102 is beneficially separated from one another to facilitate independent baseline data processes to be executed by these computing devices 102.

As illustrated in FIG. 2D, the respective database associated with the computing device 102-1 includes the initial baseline data 120-A (“1000 YARDS,” “125 BPM,” and “MAVERICKS”). Additionally, the respective database includes the predicate data 150-D (“RESTRICT BPM”). Although the initial baseline data (“125 BPM”) was deleted at the database 124 of the computing device 102-1, the initial baseline data (“125 BPM”) remains stored at the database of the storage device 104. However, the deleted data record 244 having specific sequence numbers (“110-115”) and the modification identifier (“DEL”) can provide an indication that this initial baseline data (“125 BPM”) was deleted at the computing device 102-1. Furthermore, as illustrated in FIG. 2D, the database associated with the different computing device 102-2 includes the initial baseline data 120-B (“1050 YARDS”).

As illustrated in FIG. 2E, a fifth step 250 can involve the computing device 102-1 executing a subsequent baseline data process (i.e., a “re-baseline” data process). In this example, the computing device 102-1 can provide a subsequent set of baseline data. In particular, the re-baseline data 120-E can include (“1000 YARDS,” “MAVERICKS,” and “125 BPM”). As previously described herein, this re-baseline data 120-E was previously generated during the event (e.g., afternoon surf session), and subsequently stored at the database 124 of the computing device 102-1 in conjunction with executing the initial baseline data process. In some cases, the re-baseline data 120-E can include all initial baseline data 120-A that was (1) provided in conjunction with the initial baseline data process, and (2) was not subsequently modified by either computing device 102. In this example, the re-baseline data 120-E does not include the initial baseline data (“125 BPM) as it was subsequently deleted, as illustrated in FIG. 2C. Additionally, the subsequent set of baseline data can include the deleted data record 258 that specifies that the initial baseline data “125 BPM” was previously deleted.

As illustrated in FIG. 2E, the fifth step 250 can involve the computing device 102-1 providing a payload 252 to the storage device 104. In some cases, the payload 252 can include all data generated by the computing device 102-1 that is stored at the database 124. In particular, the payload 252 can include any baseline data 120-E, providence data 140-E, and change records (e.g., deleted data records 258) generated by the computing device 102-1. For example, as illustrated in FIG. 2G, the re-baseline data 120-E can include baseline data (“1000 YARDS” and “MAVERICKS”), which were previously provided by the computing device 102-1 in conjunction with the initial baseline data process. In response to receiving the payload 252, the storage device 104 can store the deleted data record 258, the re-baseline data 120-E, and the providence data 140-E, as illustrated in FIG. 2F.

According to some embodiments, the computing device 102-1 can be configured to provide a subsequent set of baseline data that includes data that was generated by both computing devices 102-1,2. For example, the computing device 102-1 can be configured to monitor for a baseline set of data that is provided by the different computing device 102-2. However, if a threshold period of time has passed without the computing device 102-1 receiving this baseline set of data, the computing device 102-1 can determine that the different computing device 102-2 has been misplaced or lost. In response, the computing device 102-1 can take ownership of any data previously provided by the different computing device 102-2. In turn, the computing device 102-2 can execute the subsequent baseline data process, where the subsequent set of baseline data can include any data stored at the database 124 that was previously generated by the computing devices 102-1,2. In this manner, any data previously stored at the storage device 104 that was generated by the different computing device 102-2 can be deleted as a result of the subsequent baseline data process.

In another example, the computing device 102-1 can be configured to provide, in conjunction with the subsequent baseline data process, any change records associated with modifying baseline data 120 that was generated by the different computing device 102-2. For instance, if the initial baseline data 120-B (“1050 YARDS”) was deleted by the computing device 102-1, then the computing device 102-1 can establish a deleted data record for this initial baseline data 120-B. During the subsequent baseline data process, the computing device 102-1 can provide the different computing device 102-2 with this deleted data record. Subsequently, in response to receiving this deleted data record, the different computing device 102-2 can also delete this initial baseline data 120-B from its database 124.

According to some embodiments, FIG. 2F illustrates a sixth step 260 that represents the separate databases of the storage device 104 subsequent to the fifth step 250 (as described in FIG. 2E). As illustrated in FIG. 2F, the respective database associated with the computing device 102-1 can include the re-baseline data 120-E (“1000 YARDS” and “MAVERICKS”). Additionally, the respective database associated with the computing device 102-1 includes a deleted data record 262 having the specific sequence numbers (“110-115”) and the modification identifier (“DEL”). In particular, the respective database associated with the computing device 102-1 depicts that all of the initial baseline data 120-A, providence data 140-A, and the deleted data record 244 that was previously stored at the respective database has been replaced with the initial baseline data 120-F, the providence data 140-F, and the deleted data record 262.

As illustrated in FIG. 2G, a seventh step 270 can involve the different computing device 102-2 receiving a payload 272 from the storage device 104 in conjunction with the re-baseline data process. In some cases, the payload 272 can include re-baseline data 120-G, the providence data 140-G, and a deleted data record 274. In this example, the re-baseline data 120-G (“1000 YARDS” and “MAVERICKS”) is stored at the database 124. Additionally, the deleted data record 274 having the specific sequence numbers (“110-115”) and the modification identifier (“DEL”) is stored at the database 124. The different computing device 102-2 can compare the re-baseline data 120-G with its corresponding data previously stored at the database 124. In some cases, the different computing device 102-2 can compare respective corresponding baseline data 120 by utilizing their respective time stamps to determine whether to delete the previously stored data. In response to the different computing device 102-2 determining that the re-baseline data 120-G includes a more current baseline data 120 of a corresponding previous baseline data 120, the different computing device 102-2 can delete the previous baseline data 120. For example, the initial baseline data (“1000 YARDS,” “125 BPM,” and “MAVERICKS”) that were previously stored at the database 124 can be confirmed to be deleted 274 as more current corresponding baseline data 120 has been identified.

Additionally, the different computing device 102-2 can also execute a subsequent baseline data process for its data stored at the database 124. In conjunction with executing the subsequent baseline data process, the different computing device 102-2 can replace all of its data stored at its respective database of the storage device 104 with its subsequent baseline data. However, in some embodiments, the different computing device 102-2 can also be configured to retain all of its data that is stored at its respective database in the storage device 104. Thus, the different computing device 102-2 can be prevented from executing its own subsequent baseline data process.

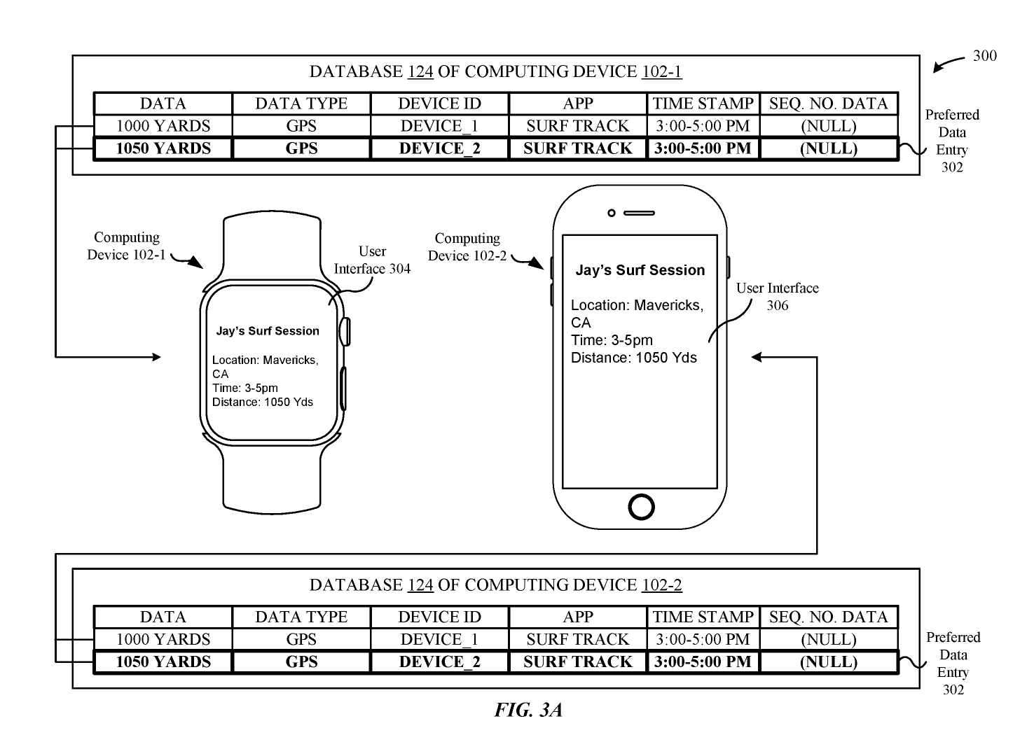

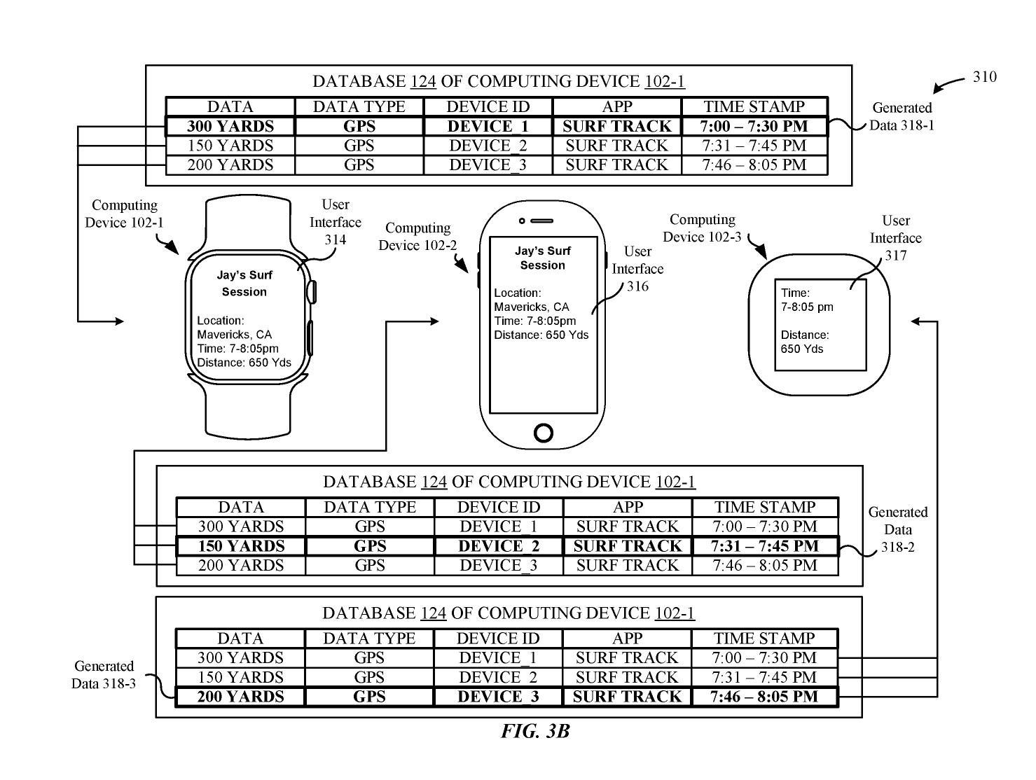

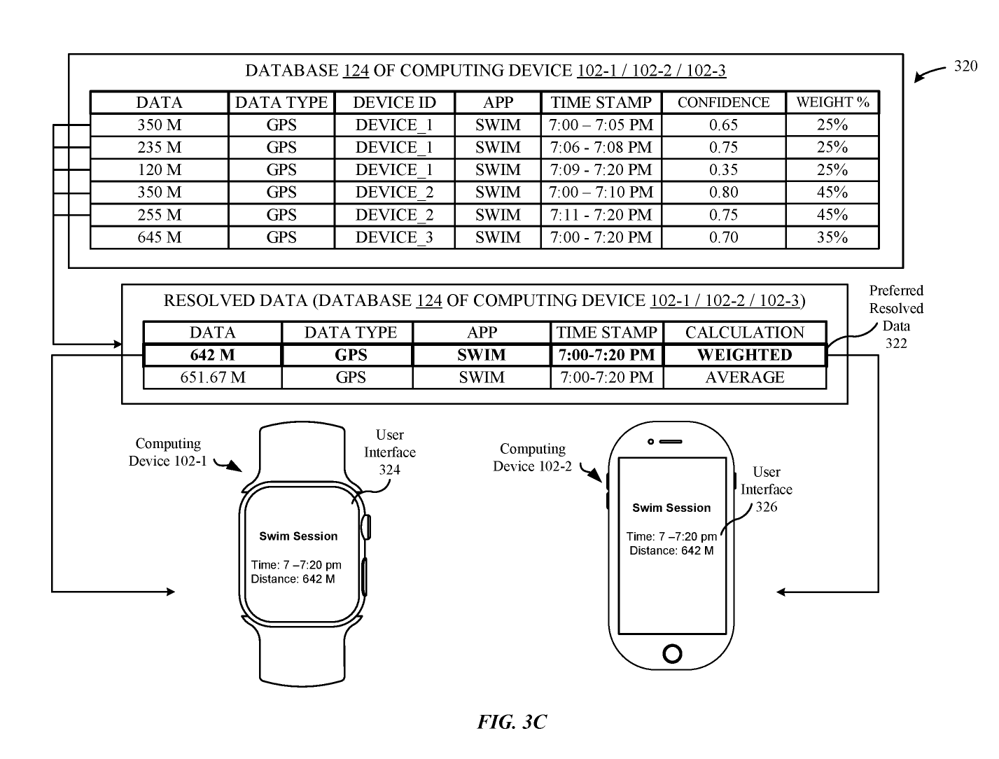

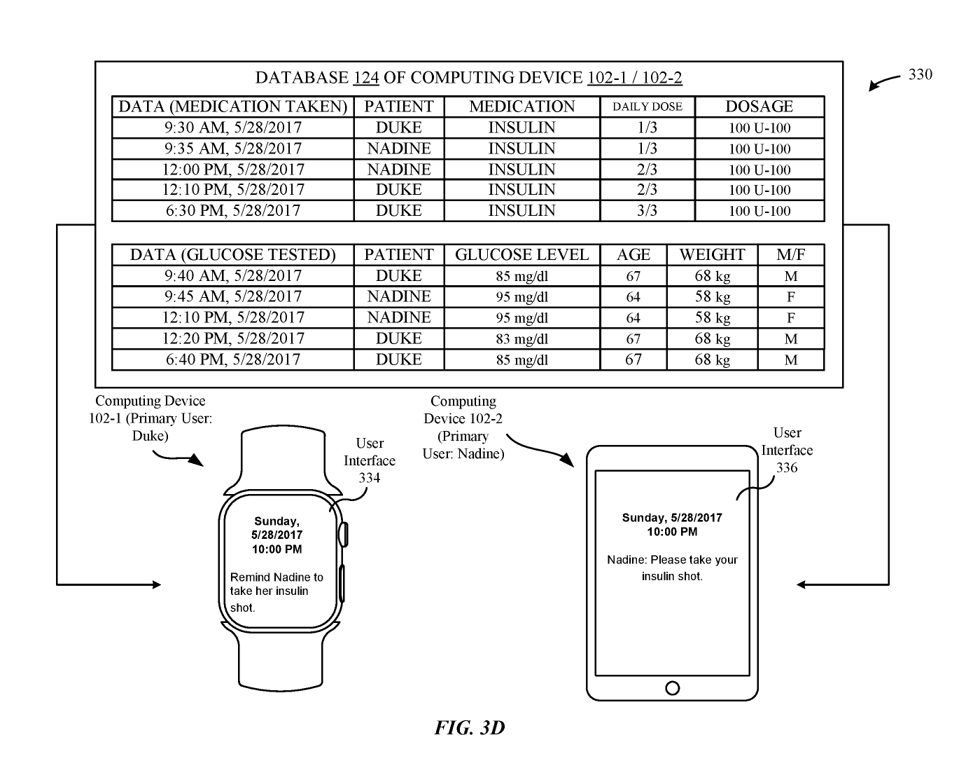

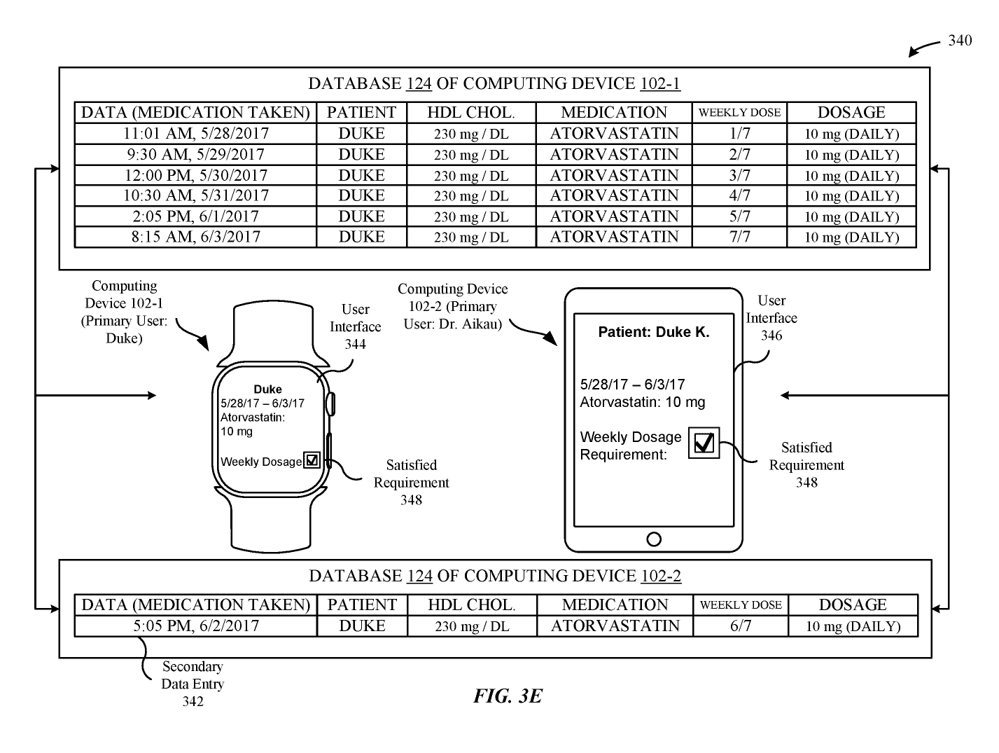

FIGS. 3A-3E illustrate example conceptual diagrams of sharing data at different computing devices, according to some embodiments. Specifically, FIG. 3A illustrates presenting resolved data at different computing devices, according to some embodiments. The example conceptual diagram 300 illustrated in FIG. 3A can occur, for example, subsequent to step 220 (as described with reference to FIG. 2B), where baseline data for the total distance surfed is shared between these computing devices. As illustrated in FIG. 3A, each of the computing devices—e.g., computing devices 102-1,2—receives a request from a user to present data associated with an occurrence of an event (e.g., the aforementioned afternoon surf session).

According to some embodiments, in response to receiving the request, each of the computing devices 102-1,2 can access the data (e.g., baseline data 120, providence data 140, predicate data 150, change records, etc.) shared in conjunction with the initial baseline data process to determine if there is at least one inconsistency in the different sets of baseline data 120 that are shared between these computing devices 102-1,2. As illustrated in FIG. 3A, the respective database 124 of each of the computing devices 102-1,2 is illustrated, where each respective database 124 includes the data (“1000 YARDS”) and (“1050 YARDS”) to represent the total distance that the user surfed during the afternoon session. In particular, each of the computing devices 102-1,2 can determine that there is an inconsistency with regard to these corresponding baseline data 120.

According to some embodiments, each of these computing devices 102-1,2 can be configured to resolve this inconsistency by applying one or more rules. In particular, each of these computing devices 102-1,2 can access the providence data 140 and the predicate data 150 associated with respective corresponding baseline data 120 in applying the one or more rules. Each of these computing devices 102-1,2 can identify where there are dissimilarities in the providence data (e.g., DEVICE ID and TIME STAMP) between these respective corresponding baseline data 120. Subsequently, each of these computing devices 102-1,2 can access the one or more rules that are applicable to these particular distinctions in providence data 140. In this example, each of these computing devices 102-1,2 has access to a rule that prioritizes GPS coordinates generated by the computing device 102-2 (“Bluetooth-enabled fitness tracker”) over GPS coordinates generated by the computing device 102-1 (“smartwatch”) for accuracy reasons. Accordingly, each of these computing devices 102-1,2 can resolve that the baseline data (“1050 YARDS”) represents the preferred data entry 302 that is to be presented to the user regarding the total distance that the user surfed. As illustrated in FIG. 3A, both of the user interfaces 304 and 306 of the computing devices 102-1,2, respectively, can present the total distance surfed by the user as (“1050 YARDS”).

According to some embodiments, FIG. 3B illustrates presenting resolved data at different computing devices, according to some embodiments. The example conceptual diagram 310 illustrated in FIG. 3B can occur, for example, subsequent to each of the computing devices—e.g., computing devices 102-1,2,3—generating data associated with an occurrence of an event (e.g., an evening surf session between 7:00 PM-8:05 PM). For example, each computing device 102-1,2,3, can generate respective baseline data 318-1,2,3 for a different time fragment so that all the different time fragments combined can make up the cumulative time period (e.g., 7:00 PM-8:05 PM). As illustrated in FIG. 3B, the respective database 124 of each of the computing devices 102-1,2,3 includes the baseline data (“300 YARDS,” “150 YARDS,” and “200 YARDS”). Additionally, each of these baseline data 120 can be distinguished by its respective providence data (“DEVICE ID” and “TIME STAMP”). In particular, the baseline data (“300 YARDS”) was generated by the computing device 102-1 between (“7:00 PM-7:30 PM”), the baseline data (“150 YARDS”) was generated by the different computing device 102-2 between (“7:31 PM-7:45 PM”), and the baseline data (“200 YARDS”) was generated by the another computing device 102-3 between (“7:46 PM-8:05 PM”). Accordingly, these separate time fragments can be combined to represent the cumulative time period (e.g., 7:00 PM-8:05 PM).

According to some embodiments, in response to receiving a request to present the data associated with the occurrence of the event (e.g., 7:00 PM-8:05 PM), each of the computing devices 102-1,2,3 can apply one or more rules to present a cumulative distance that the user surfed during the event. In particular, each of the computing devices 102-1,2,3 can access the shared data (e.g., baseline data 120, providence data 140, predicate data 150, change records, etc.) and combine the respective baseline data 120 associated with each time fragment to determine the cumulative distance that the user surfed during the event. In this example, each of these computing devices 102-1,2,3 can generate resolved data (“650 YARDS”) by combining (300 YARDS+150 YARDS+200 YARDS), which represents the cumulative distance that the user surfed during the event. As illustrated in FIG. 3B, the respective user interfaces 314, 316, 317 of the computing devices 102-1,2,3 respectively, can present the cumulative distance surfed by the user as (“650 YARDS”).

According to some embodiments, FIG. 3C illustrates presenting resolved data at different computing devices, according to some embodiments. The example conceptual diagram 320 illustrated in FIG. 3C can occur, for example, subsequent to when baseline data for a total distance swam by a user is shared between these computing devices. As illustrated in FIG. 3C, each of the computing devices—e.g., computing devices 102-1,2,3—can generate data associated with an occurrence of an event (e.g., an evening swim session between 7:00 PM-7:20 PM). However, some of these computing devices 102 can record this data in partial time fragments. For example, each computing device 102-1,2,3 can generate baseline data 120 for different time fragments that when combined, make up the cumulative time period (e.g., 7:00 PM-7:20 PM). As illustrated in FIG. 3C, the respective database 124 of each of the computing devices 102-1,2,3 can include baseline data that was generated by each of these computing devices 102 during different time fragments that make up the cumulative time period. Additionally, each of these baseline data can be distinguished by its respective providence data (“CONFIDENCE” and “WEIGHT %”), where the (“WEIGHT %”) of the baseline data 120 can be based on the confidence score (“CONFIDENCE”) of the computing device 102 that generated the baseline data 120.

According to some embodiments, in response to receiving a request to present the data associated with the occurrence of the event (e.g., 77:00 PM-7:20 PM), each of the computing devices 102-1,2,3 can apply one or more rules to present resolved data that represents the total distance that the user swam during the event. In some cases, each of the computing devices 102-1,2,3 can access baseline data 120 and its associated providence data (“CONFIDENCE” and “WEIGHT %”) to determine a total weighted distance swam by the user. In this example, the baseline data 120 generated by the computing device 102-2 is associated with the highest confidence scores (e.g., 0.80, 0.75). Accordingly, this baseline data 120 can be afforded the strongest weighted value (e.g., 45%). Subsequently, the baseline data 120 generated by the computing device 102-3 is associated with the next high confidence score (e.g., 0.70). Accordingly, this baseline data 120 can be afforded a weighted value (e.g., 35%), which is weaker than the baseline data 120 associated with the computing device 102-2. Finally, the baseline data 120 generated by the computing device 102-1 is associated with the lowest confidence scores (e.g., 0.65, 0.75, 0.35). Accordingly, the baseline data 120 generated by the computing device 102-1 is afforded the lowest weighted value (e.g., 25%).

Accordingly, each of these computing devices 102-1,2,3 can generate resolved data (“642 METERS”), which represents the total weighted distance that the user swam during the cumulative time period. For example, the total weighted distance can be derived from: Computing Device 102-1: (350 meters×0.25)+(235 meters×0.25)+(120 meters×0.25)=176.25 meters; Computing Device 102-2: (350 meters×0.45)+(255 meters×0.45)=272.25 meters; Computing Device 102-3: (645 meters×0.30)=193.5. Total Weighted Distance=642. Alternatively, each of the computing devices 102-1,2,3 can access the baseline data 120 to determine an average total distance swam by the user. In this example, each computing device 102 can generate resolved data that indicates an average total distance of (“651.67 METERS”) that was swum by the user during the cumulative time period. In some cases, the one or more rules can define that the total weighted distance is the preferred resolved data 322 over the average total distance. Accordingly, the respective user interfaces 324, 326 of the computing devices 102-1,2 can present the total weighted distance swam by the user as (“642 METERS”).

According to some embodiments, FIG. 3D illustrates presenting a notification at different computing devices that is based on shared data, according to some embodiments. The example conceptual diagram 330 can occur, for example, subsequent to each of the computing devices—e.g., computing devices 102-1,2—sharing data (e.g., user health data) that was generated in association with multiple events. In this example, these multiple events can include whenever the users (“DUKE” and “NADINE”) take their insulin injections and measure their blood glucose levels at their home. In particular, the computing device 102-1 can be associated with a primary user (e.g., “DUKE”) and a secondary user (e.g., “NADINE”), while the computing device 102-2 can be associated with a primary user (e.g., “NADINE”) and a secondary user (e.g., “DUKE”). Accordingly, any notifications generated by these computing devices 102 are prioritized to be directed towards its respective primary user, as described in greater detail herein.

According to some embodiments, each computing device 102 can store baseline data 120 (e.g., medical records) associated with the user's insulin injections and glucose level measurements at respective databases 124. These computing devices 102 can be configured to establish a medical record of a day/time of every instance when an insulin injection was taken/glucose level was measured. Additionally, the user's medical records can include associated patient data, such as the patient's age, gender, the patient's measured glucose level, the patient's weight, and the prescribed dosage of insulin. In this example, both users are required to take three injections of (100 U-100) insulin per day. Both computing devices 102-1,2 can utilize the baseline data 120 and its associated patient data to determine whether each of the users has satisfied this requirement. As illustrated in FIG. 3D, the computing devices 102 determine that the user (“DUKE”) has satisfied his daily requirement of insulin, as he received the insulin injection at (“9:30 AM,” “12:10 PM,” and “6:30 PM”). However, both computing devices 102 have determined that the user (“NADINE”) has not satisfied her daily requirement of insulin, and it is time for her scheduled bedtime (e.g., “10:00 PM”). Accordingly, both computing devices 102-1,2 can present a notification at their respective interfaces 334, 336, that alerts both users (“DUKE”) and (“NADINE”) to take her insulin injection.

According to some embodiments, FIG. 3E illustrates presenting resolved data at different computing devices, according to some embodiments. The example conceptual diagram 340 can occur, for example, subsequent to each of the computing devices—e.g., computing devices 102-1,2—establishing data in association with a day/time of when the user (“DUKE”) took his cholesterol-lowering medication (“ATORVASTATIN”). In particular, the computing device 102-1 can be associated with a primary user (e.g., “DUKE”), while the computing device 102-2 can be associated with a primary user (e.g., “DR. AIKAU”). Accordingly, any notifications generated by these computing devices 102 are directed towards its respective primary user.

According to some embodiments, the computing device 102-1 can be configured to establish baseline data 120 (e.g., medical records) of when the user (“DUKE”) took the cholesterol-lowering medication. As previously described herein, the user can manually enter these medical records into the database 124 of the computing device 102-1. In this example, the user is required to take a daily dosage of 10 mg of the cholesterol-lowering medication. In this example, both computing devices 102 can utilize the baseline data 120 and its associated patient data (e.g., “HDL CHOL.,” “MEDICATION,” “WEEKLY DOSE,” and “DOSAGE”) to determine whether the user has satisfied this requirement. As illustrated in FIG. 3E, the user (“DUKE”) appears to have missed his medication on Jun. 2, 2017. For example, the user failed to enter a medical record for Jun. 2, 2017. However, the database 124 of the different computing device 102-2 can be configured to share a medical record with the computing device 102-1 that indicates that the user took his medication at his physician's office, which was recorded using the different computing device 102-2. For example, FIG. 3E illustrates a secondary data entry 342 that is stored at the database 124 of the different computing device 102-2 that indicates that the patient took his medication at 5:05 PM on Jun. 2, 2017. Accordingly, both computing devices 102-1,2 can utilizing the sharing techniques described herein to resolve this discrepancy and present a notification at their respective interfaces 344, 346, that alerts both primary users (“DUKE” and “DR. AIKAU”) that the user (“DUKE”) has satisfied his weekly dosage requirement 348 of the medication.

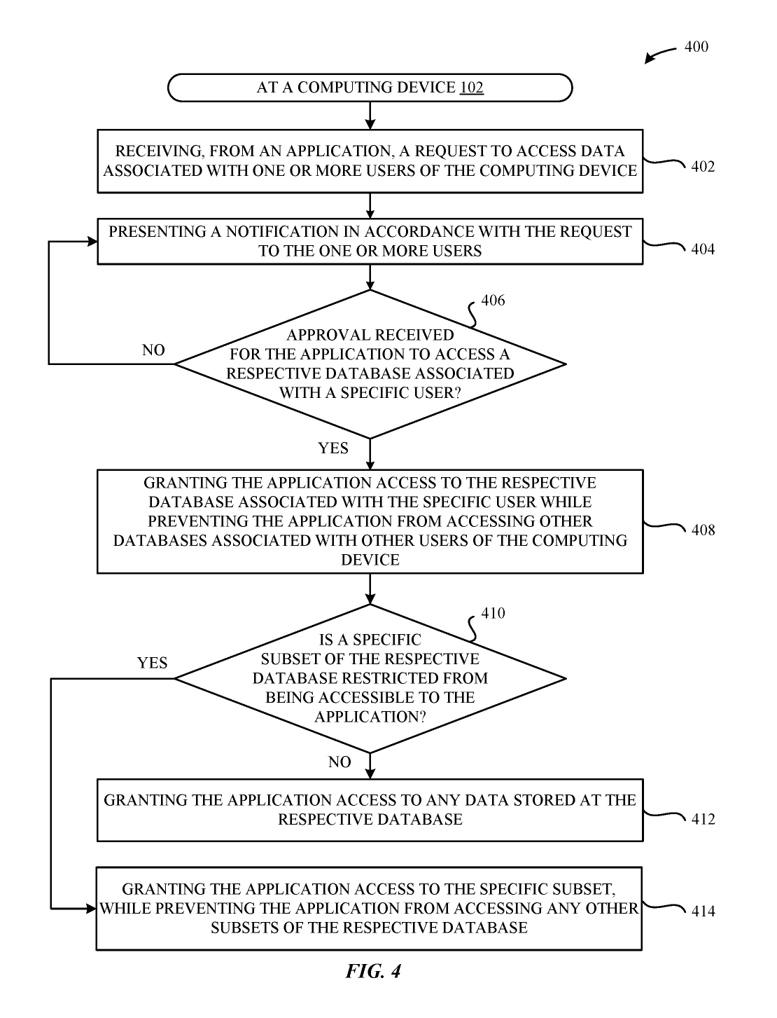

FIG. 4 illustrates a method 400 for servicing a request issued by an application to access data stored at a computing device, according to some embodiments. As illustrated in FIG. 4, the method 400 begins at step 402, where a computing device—e.g., a computing device 102-1—receives a request to access data associated with one or more users of the computing device 102-1 from an application (that is established at the computing device 102-1 or another computing device 102). This can occur, for example, subsequent to the computing device 102-1 storing data (e.g., baseline data 120, providence data 140, predicate data 150, change records, etc.) for the one or more users associated with the computing device 102-1. In some examples, the data for each user is stored exclusively at the user's respective database (e.g., 124-A through 124-N). As previously described herein, each database 124 can include a dedicated API (e.g., 130-1 through 130-N) that can be configured to control access by the application to the user's data.

At step 404, the computing device 102-1 can present a notification at a display of the computing device 102-1 in accordance with the request to access the data. At step 406, the computing device 102-1 can determine whether approval for the application to access a respective database 124 associated with a specific user of the computing device 102-1 is received. If approval to access the respective database 124 is not received, then the computing device 102-1 can continue monitoring for receipt of an approval. In particular, if the approval is not received, the computing device 102-1 can be configured to deny the application access to any of the respective databases 124 of the computing device 102-1.

At step 408, in response to determining that the approval to access the respective database 124 associated with the specific user is received, the computing device 102-1 can grant the application access to the respective database 124 associated with the specific user while also preventing the application from accessing other databases 124 associated with any other users associated with the computing device 102-1. At step 410, the computing device 102-1 can determine whether a specific subset of the data that is stored at the respective database 124 (associated with the specific user) that is accessible to the application is restricted. If the specific subset of the data is not restricted, then the computing device 102-1 can grant the application access to any of the data stored at the respective database 124, as indicated by step 412.

Returning back now to step 410, if the specific subset of the data stored at the respective database 124 that is accessible to the application is restricted, then the computing device 102-1 can grant the application access to specific subset of the specific user's data, while also preventing the application from accessing any other subsets of the specific user's data that is stored at the respective database 124, as indicated by step 414. In some cases, the computing device 102-1 can utilize predicate data 150 to define the one or more specific subsets that are accessible/inaccessible to the application. For example, the predicate data 150 can restrict the application from accessing the specific user's data that is more than 10 days old, while enabling the application to access the specific user's data that is as recent as 10 days.

In either case, when granting the application access to the data stored at the respective database 124 for the specific user, the computing device 102-1 can establish authentication protocols 132 (e.g., token-based) for the application. In particular, the computing device 102-1 can provide the application with a specific token for the respective database 124 associated with the specific user. For example, the computing device 102-1 can establish a correlation between the specific token for the respective database 124 and the application. Subsequently, when the application provides a subsequent request to gain access to the respective database 124 associated with the specific user, the computing device 102-1 can verify whether the specific token is valid in response to determining whether to grant the application access to the respective database 124.

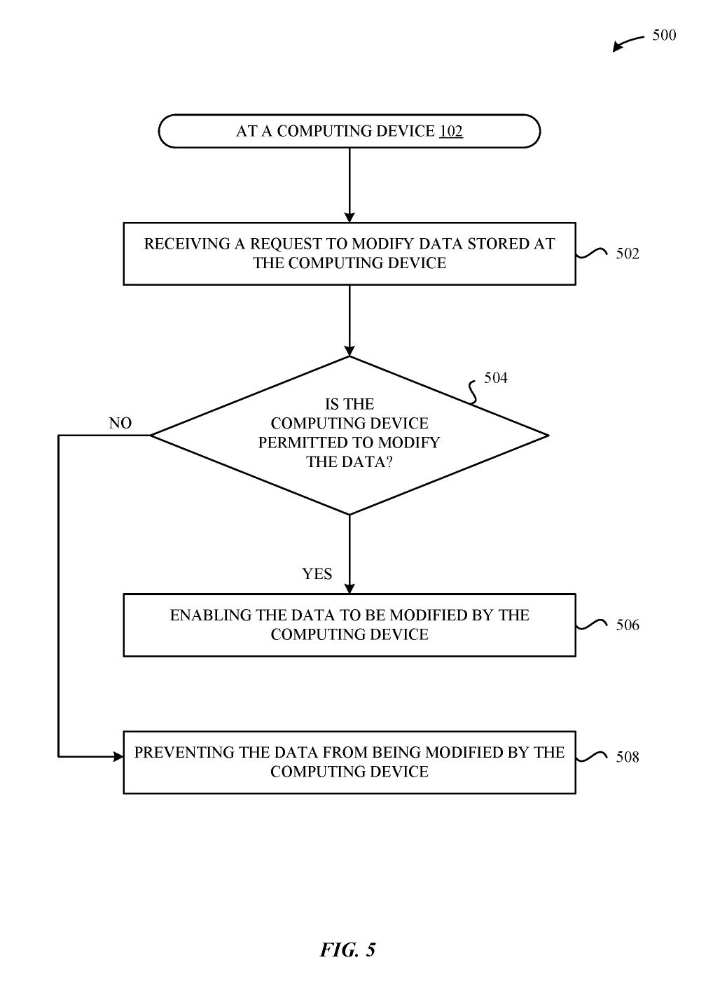

FIG. 5 illustrates a method 500 for servicing a request to modify data that is shared among computing devices, according to some embodiments. In some cases, these computing devices 102 can be defined as having a master/master relationship. In some cases, these computing devices 102 can be defined as having a parent/child relationship. In particular, a computing device 102-1 can be designated as a “parent” computing device, and a different computing device 102-2 can be designated as a “child” computing device. In this example, the parent computing device can be controlled by a parent, and the child computing device can be controlled by the parent's child. However, as the child grows older, and is more capable of making adult decisions, the child computing device can be given increased control to (1) generate data, and (2) modify data generated by the parent computing device. For example, before the child comes of age, the child computing device can be enabled (e.g., by the parent computing device) to view baseline data 120 that is generated by the parent computing device, but is prevented from modifying that same baseline data 120.

Alternatively, the parent computing device can be configured to view and modify any baseline data 120 that is generated by the child computing device. In either case, these computing devices 102-1,2 can utilize the providence data 140 and the predicate data 150 to determine restrictions that are implemented on the shared baseline data 120. For example, the providence data 140 (e.g., a specific computing device identifier) that is associated with its respective baseline data 120 can specify that the computing device 102-1 generated this baseline data 120, and the predicate data 150 can specify any restrictions for accessing/sharing this baseline data 120 (e.g., only authorize modifications to this baseline data 120 by computing devices having this specific computing device identifier).

At step 502, a computing device—e.g., a computing device 102-1—receives a request to modify data (e.g., the baseline data 120) stored at the computing device 102-1. This can occur, for example, subsequent to the computing device 102-1 sharing data with a different computing device 102-2. At step 504, the computing device 102-1 can determine whether it is permitted to modify the shared data. In some examples, the computing device 102-1 is permitted to modify the shared data if that shared data was generated by the computing device 102-1. In particular, the computing device 102-1 can utilize the providence data 140 to determine whether the data that is requested to be modified was previously generated by the computing device 102-1. As previously described herein, data (e.g., the baseline data 120) that is shared between these computing devices 102-1,2 can include the providence data 140 that specifies the specific computing device identifier associated with the computing device 102 that generated this data. In particular, the computing device 102-1 can compare its own device information 114 (e.g., computing device identifier) to the specific computing device identifier specified by the providence data 140 to determine whether this data was previously generated by the computing device 102-1. In other cases, the computing device 102-1 can utilize the predicate data 150 to determine whether this data is restricted from being modified by this computing device 102-1.

At step 506, in response to determining that the computing device 102-1 is permitted to modify this data, the computing device 102-1 can be enabled to modify the data. For example, in response to determining that its computing device identifier corresponds to the specific computing device identifier, then the computing device 102-1 can be authorized to modify this data.

Returning back to step 504, if the computing device 102-1 is not permitted to modify this data, then the computing device 102-2 can be prevented from modifying this data, as indicated by step 508. However, in some cases, the computing device 102-1 can be enabled to view this data. Accordingly, the restrictions on shared data as established by the predicate data 150 can be implemented at an individual data level. Notably and beneficially—this enables users to control the granularity of access for each data.

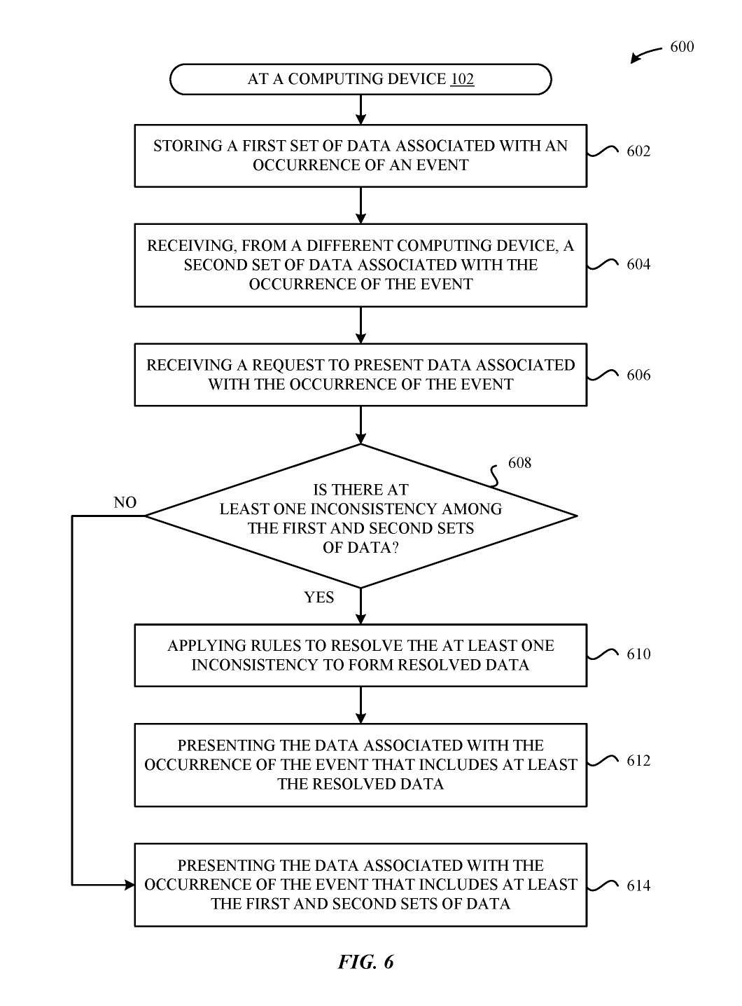

FIG. 6 illustrates a method 600 for servicing a request to present data associated with an event at a computing device, according to some embodiments. The method 600 can occur, for example, subsequent to the computing device receiving baseline data 120 in conjunction with a baseline data process, as previously described herein. As illustrated in FIG. 6, the method 600 begins at step 602, where a computing device—e.g., a computing device 102-1—stores a first set of data associated with the event.

At step 604, the computing device 102-1 can receive, from a different computing device 102-2, a second set of data associated with the event. In some examples, each of the first and second sets of data can include at least one of the baseline data 120, the providence data 140, the predicate data 150, the change records, and the like. In some cases, the second set of data that is received from the different computing device 102-2 is associated with a baseline data process executed by the different computing device 102-2.

At step 606, the computing device 102-1 can receive a request to present data associated with the event. At step 608, the computing device 102-1 can determine whether there is at least one inconsistency among the first and second sets of data. In some cases, the computing device 102-1 can determine if there is at least one inconsistency in response to receiving the request to present data. In other cases, the computing device 102-1 can determine if there is at least one inconsistency in response to receiving the second set of data.

In either case, at step 610, in response to determining that there is at least one inconsistency, the computing device 102-1 can apply one or more rules to the at least one inconsistency to form resolved data. In some cases, the computing device 102-1 can access providence data 140 and predicate data 150 to resolve the at least one inconsistency. For example, the one or more rules can be shared between these computing devices 102 as predicate data 150. Accordingly, both of these computing devices 102 can be configured to apply the same rules to the at least one inconsistency such as to present uniform data that is associated with the event.

At step 612, the computing device 102-1 can present the data associated with the event, where the data includes at least the resolved data. As previously described herein, in some examples, the resolved data can refer to a preferred data entry, where the preferred data entry corresponds to either the data generated by the computing device 102-1 or the different computing device 102-2. In other examples, the resolved data can refer to a fusion of the corresponding respective data, whereby the fusion of the corresponding respective data is presented at both of the computing devices 102-1,2. In other examples, the resolved data can be generated by applying weighted values and confidence scores. Returning back to step 608, if there is not an inconsistency among the first and second sets of data, then the computing device 102-1 can present the data associated with the occurrence of the event that includes at least the first and second sets of data, as indicated by step 614.

FIG. 7 illustrates a method 700 for servicing a request to replace a set of data stored at a storage device, according to some embodiments. The method 700 can occur, for example, subsequent to storing any set of data (e.g., baseline data 120, providence data 140, predicate data 150, change records, etc.) at a storage device—e.g., a storage device 104. In particular, the method 700 can occur subsequent to a computing device—e.g., a computing device 102-1—executing an initial baseline data process, where an initial set of data that is stored at the computing device 102-1 is provided to a storage device 104 as an initial set of baseline data. In some examples, the initial set of baseline data can include any set of data (e.g., the baseline data 120, the providence data 140, the predicate data 150, the change records, etc.). As previously described herein, the storage device 104 can store the initial set of baseline data, and subsequently provide the initial set of baseline data to a different computing device—e.g., a different computing device 102-2.

As illustrated in FIG. 7, the method 700 begins at step 702, where the computing device 102-1 modifies the initial set of baseline data that is stored at the computing device 102-1. In some cases, the modification of the initial set of baseline data can include a deletion, an edit, an addition, and so forth. For example, the initial set of baseline data can include the initial baseline data (e.g., “125 BPM,” “1000 YARDS,” and “MAVERICKS”), however, the computing device 102-1 only modifies the initial baseline data (e.g., “125 BPM”).

At step 704, in conjunction with modifying the initial baseline data, the computing device 102-1 can establish a change record that reflects the modification to the initial baseline data (e.g., “125 BPM”). According to some embodiments, the change record can be utilized to inform the different computing device 102-2 and the storage device 104 that the initial baseline data has been modified.

At step 706, the computing device 102-1 can provide the change record to the storage device 104. In turn, the storage device 104 can store the change record in a database that is exclusively dedicated to storing data that is provided by the computing device 102-1. As previously described herein, the storage device 104 can include separate databases for the computing devices 102, where a first database is exclusively dedicated to storing data that is provided by the computing device 102-1 and a second database is exclusively dedicated to storing data that is provided by the different computing device 102-2. Subsequently, the storage device 104 can provide the change record to the different computing device 102-2. In some cases, the change record can be stored at a database 124 of the different computing device 102-2. The change record can provide instructions that cause the different computing device 102-2 to alter its manner of sharing the initial baseline data (e.g., “125 BPM”). For example, when the change record reflects that the initial baseline data (e.g., “125 BPM”) was deleted at the computing device 102-1, the different computing device 102-2 can prevent this initial baseline data from being presented to a user associated with the different computing device 102-2. As previously described herein, although the different computing device 102-2 can be configured to alter the manner in which the initial baseline data is presented, the initial baseline data remains stored at the database 124 of the different computing device 102-2.

At step 708, the computing device 102-1 can determine whether at least one circumstance for replacing the initial set of baseline data that is stored at the storage device 104 is identified. According to some embodiments, replacing the initial set of baseline data can be executed in conjunction with the computing device 102-1 executing a subsequent baseline data process. In some cases, the computing device 102-1 can provide an updated set of baseline data that replaces all of the data stored at the dedicated database of the storage device 104. In some examples, all of the data that is replaced at the storage device 104 can include any of the baseline data 120, the providence data 140, the predicate data 150, or the change records.

According to some embodiments, the at least one identified circumstance for executing the subsequent baseline data process can be identified by the computing device 102-1. According to some embodiments, the user of the computing device 102-1 can initiate the subsequent baseline data process. In other embodiments, the different computing device 102-2 can request that the computing device 102-1 execute the subsequent baseline data process. According to some embodiments, the at least one identified circumstance can refer to old active zones that are present. In some example, data included in the old active zones can refer to baseline data 120 that is stored at the database 124 and which was previously provided to the storage device 104. Accordingly, in conjunction with executing a subsequent baseline data process, the computing device 102-1 can replace data stored at the respective database of the storage device 104 that corresponds to the data included in the old active zones.

According to some embodiments, the at least one identified circumstance can refer to inactive zones. In some examples, the data included in the inactive zones can refer to data, which was not previously provided to the storage device 104. In response to determining that the data in these inactive zones has not been recently updated/modified, the computing device 102-1 can delete these inactive zones.

According to some embodiments, the at least one identified circumstance can refer the presence of no currently established zones associated with this computing device 102-1. In particular, when a zone is established, it can be identified using the specific device identifier associated with the computing device 102-1 that generated this data. In response to determining that there are no currently established zones, the computing device 102-1 can establish zones that include data. In some examples, the presence of no currently established zones can occur when the computing device 102-1 has not previously provided any baseline data to the storage device 104.

According to some embodiments, the at least one identified circumstance can refer to identifying that a computing device 102-3 that provided the initial set of baseline data that is stored at the storage device 104 has been misplaced or lost. As previously described herein, each of the computing devices 102 has a dedicated database at the storage device 104 for exclusively storing its data. Additionally, each dedicated database can be associated with a database identifier that corresponds to the specific device identifier of the computing device 102. Accordingly, if the computing device 102-3 has been misplaced, the computing device 102-1 can become associated with the respective database associated with the computing device 102-3. In conjunction with establishing this change in association, the database identifier of the dedicated database is altered to correspond to the specific device identifier of the computing device 102-1. Subsequently, if the computing device 102-3 is later found, then the storage device 104 can establish a dedicated database that is associated with the computing device 102-3.

According to some embodiments, the at least one identified circumstance can refer to identifying that the number of change records established as a result of modifying the initial set of baseline data has exceeded a threshold value. As the storage device 104 should be continually updated to provide an up-to-date mirror of the changes to the initial set of baseline data, the computing device 102-1 can be configured to execute a subsequent baseline data process to replace the current set of baseline data that is stored at the storage device 104.

At step 710, the computing device 102-1 can provide an updated set of baseline data to the storage device 104. Accordingly, the storage device 104 can replace the initial set of baseline data with the updated set of baseline data. In turn, the storage device 104 can provide the updated set of baseline data to the different computing device 102-2. Returning back to step 708, if the computing device 102-1 determines that the at least one circumstance for executing the subsequent baseline data process has not been identified, then the computing device 102-1 can be prevented from generating an updated set of data, as indicated by step 712. In this manner, the initial set of baseline data remains stored at the storage device 104.

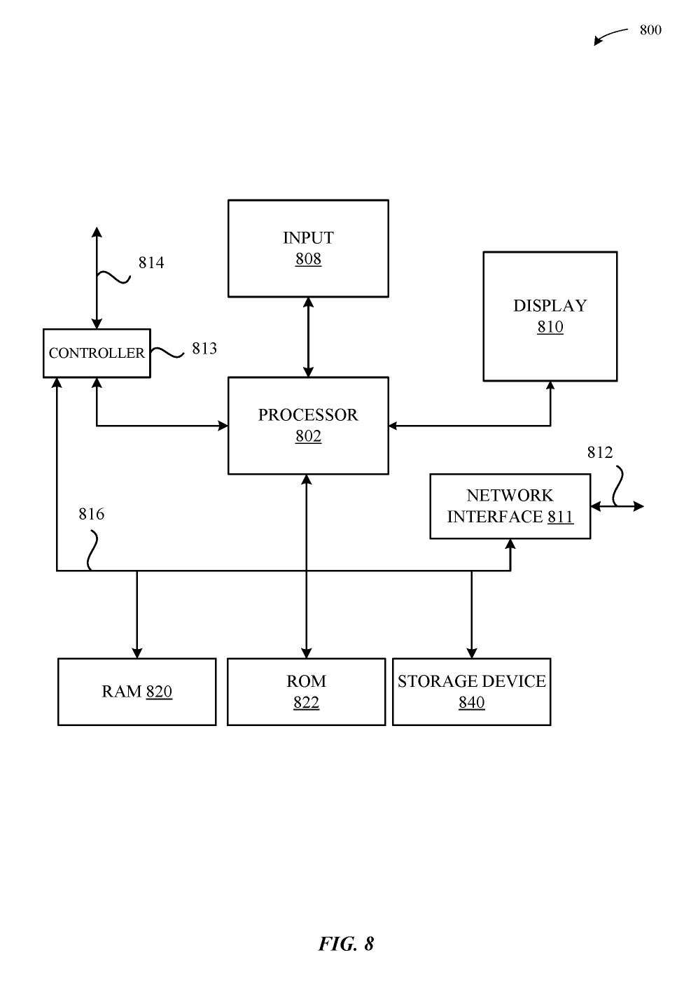

FIG. 8 illustrates a detailed view of a computing device 800 that can represent the different computing devices of FIG. 1 used to implement the various techniques described herein, according to some embodiments. For example, the detailed view illustrates various components that can be included in the computing devices (e.g., 102-1 through 102-N) described in conjunction with FIG. 1. As illustrated in FIG. 8, the computing device 800 can include a processor 802 that represents a microprocessor or controller for controlling the overall operation of the computing device 800. The computing device 800 can also include a user input device 808 that allows a user of the computing device 800 to interact with the computing device 800. For example, the user input device 808 can take a variety of forms, such as a button, keypad, dial, touch screen, audio input interface, visual/image capture input interface, input in the form of sensor data, and so on. Still further, the computing device 800 can include a display 810 that can be controlled by the processor 802 (e.g., via a graphics component) to display information to the user. A data bus 816 can facilitate data transfer between at least a storage device 840, the processor 802, and a controller 813. The controller 813 can be used to interface with and control different equipment through an equipment control bus 814. The computing device 800 can also include a network/bus interface 811 that couples to a data link 812. In the case of a wireless connection, the network/bus interface 811 can include a wireless transceiver.

As noted above, the computing device 800 also includes the storage device 840, which can comprise a single disk or a collection of disks (e.g., hard drives). In some embodiments, storage device 840 can include flash memory, semiconductor (solid state) memory or the like. The computing device 800 can also include a Random-Access Memory (RAM) 820 and a Read-Only Memory (ROM) 822. The ROM 822 can store programs, utilities or processes to be executed in a non-volatile manner. The RAM 820 can provide volatile data storage, and stores instructions related to the operation of applications executing on the computing device 800.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for resolving inconsistencies in synchronized data among multiple computing devices, the method comprising, at a first computing device storing a first set of data that is associated with an event:
receiving, from a second computing device, a second set of data that is associated with the event;
in response to receiving a request to present data associated with the event:
determining a presence of at least one inconsistency between respective corresponding data of the first and second sets of data,
applying rules to the at least one inconsistency to form resolved data, and
presenting the data associated with the event, wherein the data includes at least the resolved data.

2. The method of claim 1, wherein, in response to determining that there is no inconsistency between the respective corresponding data, the method further comprises:
presenting the data associated with the event, wherein the data includes at least the first and second sets of data.

3. The method of claim 1, wherein the first computing device receives the second set of data from a storage device that is accessible to the first and second computing devices.

4. The method of claim 1, wherein the first set of data is associated with a device identifier that indicates that the first set of data was generated by the first computing device, and the second set of data is associated with another device identifier that indicates that the second set of data was generated by the second computing device.

5. The method of claim 1, wherein the first set of data is stored at a select database, and the method further comprises:
storing the second set of data at another database that is different than the select database, wherein each of the select database and the another database includes a respective application programming interface that controls access to the first and second sets of data.

6. The method of claim 5, wherein, in response to receiving, from a different computing device, a request to access the first set of data, the method further comprises:
receiving an approval to grant the different computing device access to the first set of data;
determining whether a specific subset of the first set of data that is accessible to the different computing device is restricted; and
in response to determining that the specific subset is restricted:
granting the different computing device access to the specific subset of the first set of data, while preventing any other subsets of the first set of data from being accessible to the different computing device.

7. The method of claim 5, wherein, in response to receiving a modification request to alter the second set of data, the method further comprises:
determining whether the second set of data was generated by the first computing device; and
in response to determining that the second set of data was not generated by the first computing device:
preventing the second set of data from being altered.

8. The method of claim 1, wherein the resolved data corresponds to either the first set of data or the second set of data.

9. At least one non-transitory computer readable storage medium configured to store instructions that, in response to being executed by at least one processor included in a first computing device that stores a first set of data that is associated with an event, cause the first computing device to:
receive, from a second computing device, a second set of data that is associated with the event;
in response to receiving a request to present data associated with the event:
determine a presence of at least one inconsistency between respective corresponding data of the first and second sets of data,
apply rules to the at least one inconsistency to form resolved data, and
present the data associated with the event, wherein the data includes at least the resolved data.

10. The at least one non-transitory computer readable storage medium of claim 9, wherein, in response to determining that there is no inconsistency between the respective corresponding data, the at least one processor further causes the first computing device to:
present the data associated with the event that includes at least the first and second sets of data.

11. The at least one non-transitory computer readable storage medium of claim 9, wherein the first set of data is associated with a device identifier that indicates that the first set of data was generated by the first computing device, and the second set of data is associated with another device identifier that indicates that the second set of data was generated by the second computing device.

12. The at least one non-transitory computer readable storage medium of claim 9, wherein the first set of data is stored in a select database, and the at least one processor further causes the first computing device to:
store the second set of data at another database that is different than the select database, wherein each of the select database and the another database includes a respective application programming interface that controls access to the first and second sets of data.

13. The at least one non-transitory computer readable storage medium of claim 9, wherein, in response to receiving a modification request to alter the second set of data, the at least one processor further causes the first computing device to:
determine whether the second set of data was generated by the first computing device; and
in response to determining that the second set of data was not generated by the first computing device:
prevent the second set of data from being altered.

14. The at least one non-transitory computer readable storage medium of claim 9, wherein the rules are based on at least one of a user preference, a frequency of usage, a calibration setting, or a pattern of usage.

15. A method for controlling access to data items that are associated with multiple users, the method comprising, at a computing device:
receiving a request, from an application, to access the data items that are stored at the computing device, wherein the data items include at least (1) a first set of data that is associated with a first user that is stored at a first database, and (2) a second set of data that is associated with a second user that is stored at a second database;
determining whether an approval for the application to access a database associated with a specific user is received, wherein the specific user includes at least one of the first user or the second user; and
in response to determining that the approval for the application to access the database is received:
determining that the application is restricted to accessing a specific subset of data stored at the database that is associated with the specific user, and
enabling the application to access the specific subset of data while preventing the application from accessing any other data stored at the database.

16. The method of claim 15, wherein the first database exclusively stores the first set of data that is associated with the first user, and the second database exclusively stores the second set of data that is associated with the second user.

17. The method of claim 15, wherein each of the first database and the second database include a respective application programming interface that controls access to their respective set of data.

18. The method of claim 15, wherein the any other data that the application is prevented from accessing includes any other subset of the data stored at the database.

19. The method of claim 15, wherein the specific subset of data includes predicate data that prevents the any other data from being accessible to the application.

20. The method of claim 15, wherein the application is established at the computing device or another computing device.
